(19) United States
(12) Patent Application Publication
(10) Pub. No.: US 2009/0217035 A1
(43) Pub. Date: Aug. 27, 2009

(54) Bilaterally Generated Encryption Key System

(76) Inventor: Abdul Rahman Syed Ibrahim Abdul Hameed Khan, Tamil Nadu (IN)

Correspondence Address: S. A. Abdul Rahman;C/o: Mr. Manny C Raja, 1507, Berlin Road, Cherry Hill, NJ, 08003, US

(21) Appl. No.: 11/913,555

(22) PCT Filed: May 4, 2006
(86) PCT No.: PCT/IN2006/000157

§ 371 Date: Apr. 20, 2009

(30) Foreign Application Priority Data
May 4, 2005 (IN) PCT/IN2005/000141

(51) Int. Cl. H04L 9/32; H04L 9/06

(52) U.S. Cl. 713/168; 380/44; 713/182

(57) ABSTRACT

Bilaterally Generated Encryption Key System is a variable password based computationally non intensive symmetric encryption key system dispensing with memorization and exchange of keys, capable of providing one encryption key for each object exchanged between two parties, two different encryption keys per transaction and a plurality of encryption keys for a session, integrating authentication and securing transactions preventing breaking attempts. The Password/Encryption Key is a random permutation of Character Units of Variable Character Set System of authentication devices {FIG. 3}, generated by a Call of random numbers from SERVICE PROVIDER and corresponding Response of USER. Bilaterally Generated Encryption Keys and Non Repeating Bilaterally Generated Encryption Keys are two types of Password/Encryption Keys. Secures every Internet/network transactions of USERs {FIG. 6} including Previously Unknown USERs, by generating many Password/Encryption Keys of required length using a padding method, from single Password/encryption key input of users and previously unknown users at the instant of transaction.

### TECHNICAL FIELD

The invention relates to Bilaterally Generated Encryption Keys System, a variable password based computationally non intensive symmetric encryption key system dispensing with exchange of keys, capable of providing one encryption key for each object exchanged between two parties, two different encryption keys per transaction and a plurality of encryption keys for a session, generating many variable keys of required length from single key input of users and previously unknown users at the instant of transaction, further capable of preventing breach attempts.

### PRIOR ART

This application claims the benefit of PCT International Application No: PCT/IN2004/000141 filing date: 4 May 2005, submitted by the same inventor and is hereby incorporated by reference, in its entirety. The previous application disclosed predominant use of the invention as Password. The present application focuses on symmetric encryption key system.

Encryption is the process of converting obvious information/data in to non obvious strings of characters, using an encryption key. The non obvious strings of characters are transmitted to the intended receiver, who converts it back to obvious information/data using the same/corresponding decryption key. The method of conversion to non obvious strings of characters is called Cryptography. The key is secret and known only to sender and receiver to ensure secure exchange of information/data. In the prior art the key must be changed periodically to prevent compromise.

One of the cryptographic methods is the group of symmetric key methods. For two users to communicate successfully using symmetric keys, each user must use the same key or inverse keys to encrypt the message. Examples of symmetric key cryptosystems are: Block-Cipher algorithms which has further sub categories like Electronic Code Book (ECB), Cipher Block Chaining (CBC), Cipher-Feedback (CFB), Output-Feedback (OFB) processes. Another popular symmetric key system is the data encryption standard or “DES”, published by the National Institute of Science and Technology (U.S.) in January 1977 in FIPS-PUB-46. Systems like triple DES and AES are further development of this method. Some symmetric key systems are known to exist where cryptographic keys are not exchanged but generated both at the sender and the receiver based on a common algorithm using a memorized PIN and the date and/or the time of the day as a dynamic variable. These systems do not provide the level of security provided by other encryption systems of prior art.

The second main category of cryptographic methods is the Public key/Private key cryptography system which uses two separate keys for encryption and decryption of messages or data. One of the keys is private and only held by its owner. The other key is public, that is, available to everyone within the network. All information sent to a person is encrypted by a person's public key. This information could be decrypted only by using the person's private key. Public key cryptography is susceptible to spoofing.

The computational need of the symmetric key systems' is low and they are easy to use, however there is a serious disadvantage that the keys are necessarily be changed frequently to ensure safety. Whenever key is changed it has to be communicated to the user. The security of the public key systems is very high and the problem of key exchange is eliminated, however the computational need of such systems is extremely high. The disadvantage of both systems is that the cryptographic keys used are too long (24 to 32 characters) to be remembered and therefore stored in a computer or data storage device or sometimes transmitted along with message in hashed condition. In both systems, the authentication of sender/receiver is established mostly by static password. When the password is breached, encryption key could be accessed and security is breached defeating the very purpose of encryption. Further the same keys are used for a long time spanning many sessions. With advance in technology and increase of processing speeds, encryption keys are breached in matter of hours. The days of using same encryption keys for many sessions or using same keys for a session are numbered.

There are many ways in which any person may attempt to break an encryption key without having the key and/or algorithm. Systematic trial by checking for correct value using every possible character combination as keys is the one which succeeds mostly. This method succeeds because the encryption key is used for many sessions, does not change and unlimited number of attempts are allowed for any one to breech the key. Prior art does not prevent the unauthorized, from making breach attempts. If some one attempts to breach the key, the attempt should be prevented by the system, by not allowing more than preagreed number of chances and breach even if happens, shall happen long after genuine transactions are completed. Such features are not available in the prior art.

WO 02/073377 date of publication: 19.09.2002 provides password useable as encryption key. It provides one encryption key per session. It requires memorization to produce password. The password is produced using a graphical user interface, that constraints the number of characters used. It takes the help of other encryption key systems also to initially secure the password. Before the secure session starts, the encryption keys are furnished in less secure user terminals providing opportunity for security breach. The disadvantages of using single encryption key for a session are similar to use of single password for authentication of a session. After user has been authorised to do transactions and begins the session, some one else could do transactions using remote commands committing financial frauds. Key capture by spyware/virus/malicious codes result in breach of security.

With the deficiencies of prior art systems and increase of speed of processing, breaking of passwords and encryption keys becomes easier, faster, that weakens the secure data transmission capabilities of prior art. Therefore it is urgently necessary to evolve a system of encryption keys where the keys are useable for securing only one object or only one transaction, so as to make it unviable for any one to attempt breaching of encryption keys; preventing attempts to breach; to combine authentication and securing by encryption together; without memorization; without storing pre-formed keys; with preferably short keys; but providing the required level of security.

The present Invention addresses the needs of Internet transaction security, combines authentication and securing transactions, aims to provide one encryption key for each object exchanged between two users, two different encryption keys per transaction and a plurality of encryption keys for a session, generating the keys from single key input of users and previously unknown users which is economical, user friendly, designable encryption key system overcoming the above mentioned deficiencies in prior art. The present invention dispenses with memorization/exchange of keys. The keys of present invention is not pre-formed and stored but generated at the instant of transaction and are shorter than that are used by DES & AES (3 characters for equivalent of DES and 7/11/14 characters for AES—128/192/256 bit, using font/distinguishing property modified characters). Providing one encryption key useable for one object or one transaction does not warrant user being called upon to furnish many keys. The System provides a method for generating many different variable encryption keys from users' single key input. In the present invention, neither the key is static nor unlimited number of attempts are allowed for any one to breech the key. Therefore even shorter length encryption key is useable.

Publication No: US 2004/0123151 publication date 24 Jun. 2004, is a prior art password system using Random Partial Pattern Recognition principle. This system uses an authentication device having patterns as identifying units. Patterns are based on cognitive functions of position in the ordered set of data fields, which are easy to remember and operate. The patterns/pattern forming rules are memorized. This limits the number of patterns used in the authentication device to human memorisable level (about 9 only). Patterns are related to the serial number identifying the patterns. Also the patterns among themselves are related. The graphical characters of password occur at specified field location in graphical user interface corresponding to serial number identifying the patterns. This identifies graphical part of the patterns, serial number wise. The alphanumeric part of pattern is discernible within one password. Existence of relationship and identification of graphical part of the patterns, serial number wise, results in compromise of patterns and subsequent passwords. Patterns are too long and passwords are longer than any other variable password system. Finding characters through graphical user interface using starting point and reading path for each one of the graphical character in addition to keying in alphabets and numbers according to the patterns, is more difficult. The passwords are created with lot of efforts from user and not adoptable for authenticating individual transactions or authenticating objects. The system requires additional securing system to secure transactions and has not disclosed any thing on encryption. Graphical user interface is required to display and can not be used in systems not having suitable display devices such as mobile phones, cameras. Certain features used in the authentication device, such as use of combination of alpha numeric and graphical characters, colours and property modification of characters are part of prior art, which have been adopted to suit the present invention.

### OBJECT OF THE INVENTION

The present invention has the following objectives:

A self reliant system that authenticates by Password, use the same Password as encryption key or modify the Password by padding to generate encryption keys of required length to secure Internet/network transactions which shall provide encryption keys, linked to the identity of user at the rate of one encryption key for each object exchanged between two parties, two different encryption keys per transaction and a plurality of encryption keys for a session.

The system shall dispense with requirement on user to memorize for Password/Encryption Key. The system shall also dispense with requirement of exchange of keys.

The security provided by the encryption keys is equal or higher than what is available in the present encryption keys systems and security level is not predetermined by the encryption keys system but designable by service provider suiting the requirement of users. Breach attempts should be prevented when user and service provider are in session as well as after the session ends.

The apparatus, method of generation and verification mechanism have to be suitable for generating a multitude of encryption keys, easily so as to make it available for each object/transaction.

When human control is required for encryption, it is burdensome for human user to furnish individual encryption keys for every transaction. Hence the system is designed to produce many encryption keys using only one initial password/encryption key furnished by user in a session. Further if the length of the keys required is long, then the system should produce additional characters, without efforts from users, and any desirable length of encryption key is generated.

When a service provider has to come across new users/previously unknown users, every transaction of such users has to be secured with separate encryption keys.

Preferably Service provider's systems with higher security shall initiate the secure session and the user terminal with lower security shall furnish Passwords/Encryption Keys within secure session. This requirement is specific to systems that combine authentication and securing transactions not using public key private key encryption system.

The cost is minimal and commensurate with the security.

### SUMMARY OF THE INVENTION

With above objectives, the invention is summarized below:

The first embodiment of the invention is directed to the Bilaterally Generated Encryption Key System, securing each one of the Internet/network transactions of users/previously unknown users by providing two different computationally non intensive encryption keys linked to user's identity for each transaction.

The second embodiment of the invention is directed to the Variable Character Set system of authentication devices, using which the encryption keys are generated, having Variable Character Set, Master Variable Character Set, Sub Variable Character Set and Sub Variable Character Set of level 2 and below, including their method of generation and use.

The third embodiment of the invention is directed to a method of repeated variation of font/distinguishing properties as means of differentiation between same characters of Password/Encryption Key, in printed authentication devices of the second embodiment to obtain higher variability, safety and flexibility of the second embodiment.

The fourth embodiment of the invention is directed to the transformation of the second embodiment to obtain higher safety.

The fifth embodiment of the invention is directed to the process of generating Encryption keys including padding of characters to make encryption keys of required length.

The sixth embodiment of the invention is directed to the Bilaterally Generated Encryption Keys generated using the above embodiments.

The seventh embodiment of the invention is directed to the Non Repeating Bilaterally Generated Encryption Keys generated using the above embodiments.

The eighth embodiment of the invention is directed to the method of authentication and securing of every individual Internet Contract/Network transactions of user with one Password/Encryption key furnished by a user for each transaction in which each of the individual actions/objects exchanged between user and service provider are authenticated using the Call and Password as two different passwords/encryption keys for each transaction, using above embodiments.

The ninth embodiment of the invention is directed to the method of authenticating and securing of every individual Internet Contract/Network transaction of a user with different passwords/encryption keys, generating the said different passwords from a single password/encryption key furnished by user at the beginning of a session and every transaction is authenticated/secured with different password/encryption key so generated in which each of the individual actions/objects exchanged between user and service provider are authenticated/secured using the Call and Password as two different passwords/encryption keys for each transaction using above embodiments.

The tenth embodiment of the invention is directed to the method of authentication and securing of every individual Internet/Network transaction of a previously unknown user with different passwords, generating said different passwords from single Password furnished from a temporary authentication device at the beginning of a session and every transaction is authenticated with different password so generated in which each of the individual actions/objects exchanged between user and service provider are authenticated using above embodiments.

### DETAILED DESCRIPTION OF THE INVENTION

A detailed description of the invention is provided below. While the invention is described in conjunction with specific embodiments, it should be understood that the invention is not limited to specific embodiments. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical field related to the invention has not been described in detail.

Definitions: For the purpose of this description, the technical terms used are defined below.

Authentication device: It is the means of generating Password/Encryption keys in the Bilaterally Generated Encryption Key System and includes Variable Character Set/Sub Variable Character Set of any level for USERs and Variable Character Set/Master Variable Character Set for SERVICE PROVIDERs with an associate Sub Variable Character Set of any level in brief form.

Authentication and securing of every individual transactions: It is to authenticate every individual transaction using different Passwords/Encryption keys linked to USER and providing different encryption keys for encrypting every transaction.

Bilaterally Generated Encryption Key System: It is an Encryption key system, integrating authentication and securing every Internet/network transactions of users, in which, the Password/Encryption keys are generated bilaterally, by USER and SERVICE PROVIDER acting together, at the instant of transaction and the Passwords/Encryption keys are variable for every transaction. USER furnished Encryption Key is optionally padded to get keys of required length.

Bilaterally Generated Encryption Key (BIGENK): It is a Password/Encryption key generated using the Bilaterally Generated Encryption Key system in which, in any Call, any Character Unit of the Variable Character Set/Sub Variable Character Set of any level that has been called previously for a Encryption key could be called again and again for subsequent Encryption keys without any restriction and an Encryption key could repeat rarely.

Call: it is a Call of SERVICE PROVIDER to USER or vice versa, in terms of serial numbers of Character Units, requiring a Response to furnish Character Units of the authentication device. The Call is made of instantly generated random numbers, each of which is equal to or less than the total number of Character Units of authentication device and validated for predetermined rules if any. The Call optionally includes identification number of a Sub Variable Character Set of any level.

Chance of Breach: It is the probability of success on random trial to arrive at the correct Encryption key by a person other than USER or SERVICE PROVIDER within the number of chances.

Human USER: Human USER is a USER who is a person.

Internet Contract Transaction (ICT): It is any Internet transaction, which has some monetary or other value between a USER and a SERVICE PROVIDER, using directly, the USER's account with that SERVICE PROVIDER or indirectly, using USER's account with any other SERVICE PROVIDER.

Maintaining link: It is to ensure the link between USER/USER Agent Software and SERVICE PROVIDER is unchanged from beginning to end of a session and both USER/USER Agent Software and SERVICE PROVIDER are the one and the same from beginning to end of a session.

Network Transaction It is any Local Area/Wide Area Network transaction, which has some monetary or other value between a USER and a SERVICE PROVIDER, using directly, the USER's account with that SERVICE PROVIDER or indirectly, using USER's account with any other SERVICE PROVIDER.

Non-Repeating Bilaterally Generated Encryption Key (NRBIGENK): It is an Encryption key which is generated using the Bilaterally Generated Encryption Key system in which, in any Call, a fixed number of Character Units out of the total number of Character Units of the Variable Character Set/Sub Variable Character Set of any level, forming an Encryption key, are called for the first time in the span of use of the authentication device between two optional transformation/font/distinguishing property changes. The balance number of Character Units out of the total number of Character Units forming an Encryption key only is/are repeatedly called and no Encryption key repeats.

Number of chances: It is the permissible number of times of furnishing the correct Encryption key in one attempt. Depending on the security requirement, it is kept as only one or two or three.

Objects exchanged between USER and SERVICE PROVIDER: The objects include Passwords, Encryption keys, Calls, files or message packets generated in transactions individually or collectively, which are swapped between USER and SERVICE PROVIDER in Internet/Network transactions.

Padding of encryption keys: It is a process of adding additional characters to the user furnished encryption key to make the key of required length

Previously unknown USER: Previously unknown USER is a USER who is yet to establish an USER account with the SERVICE PROVIDER with whom USER wants to transact and includes temporary/short duration USERs excused from having an USER account.

Providing proof for a transaction: It is to preserve the Call and Password/Encryption key of each transaction as the proof of that transaction along with Internet Protocol address wherefrom USER transacted, date, time and USER's details, including Internet Protocol address of Internet Service Provider/Network Server who forwarded the request of previously unknown USERs.

Response: It is the answer furnished for a Call, in terms of Character Units of the authentication device, whose serial numbers of Character Units are the numbers called in the order of Call, typed as continuous string of Character Units, in which the Basic Characters are indistinguishable as belonging to particular Character Unit. When the Call includes identification number of a Sub Variable Character Set of any level, then the Response also includes identification number of that Sub Variable Character Set of any level.

SERVICE PROVIDER: SERVICE PROVIDER is a person or a process or software or specified sector(s) of data storage media or a system or server or a Network or any thing who/which provides access to the USER upon furnishing of valid Password/Encryption keys to authenticate himself/herself/itself.

Stronger Encryption key: It is an Encryption key, which has twice the normal number of Character Units in a Call, designed to test physical availability of authentication device with USER after a failed attempt.

Temporary authentication device: It is an authentication device sent by a SERVICE PROVIDER to a previously unknown USER through the Internet Service Provider/Network Server.

Transaction: It comprise of an action of USER and the subsequent Response of SERVICE PROVIDER.

USER: USER is a person or a process or software or specified sector(s) of data storage media or a system or server or a Network or any thing who/which uses a Password/Encryption key to authenticate and secure transactions between USER and SERVICE PROVIDER.

USER object: USER object is a USER, other than a Human USER.

USER Agent Software: It is a specially designed software program, representing USER and transacting with SERVICE PROVIDER. It is integrated with Internet Contract Transaction/Network Transaction software or used as independent software. It functions from the USER's system to perform authentication/securing of individual transactions, authentication/securing and exchanging objects on behalf of the USER, checking for origination of USER's message from within USER's system and passing on the objects received from SERVICE PROVIDER to USER.

### LIST OF ABBREVIATIONS/SYMBOLS/CONVENTIONS USED

### BC Basic Character

### BIGENK Bilaterally Generated Encryption Key

### CU Character Unit

### ICT Internet Contract Transaction/Network Transaction

IP address Internet Protocol address
ISP Internet Service provider/Network Server

### LAN Local Area Network

### MVCS Master Variable Character Set

### NRBIGENK Non-Repeating Bilaterally Generated Encryption Key

SNCU Serial number of Character Unit

### SVCS Sub Variable Character Set

### PSI Password Safety Index.

### VCS Variable Character Set

VLN Very large number exceeding 10³⁰⁷

### WAN Wide Area Network

To indicate plural “s” is added to all abbreviations.

### = Equal

### + Addition

### − Subtraction

### * or: × Multiplication

### / Division

̂ Exponential
log N Logarithm of ‘N’ to the base 10
ⁿPᵣ Number of permutations of ‘r’ objects out of a total of ‘n’ objects
7.86E+07 7.86×10⁷(Convention used for large numbers)

The terms ‘USER’ and ‘SERVICE PROVIDER’ with all letters capitalized are used, where the defined meanings are applicable. Where, ‘User’ or ‘user’ and ‘Service provider’ or ‘service provider’ or their plurals occur, they denote only the persons, who are seeking authentication or a person or system, accepting authentication. All other technical terms will have their defined meanings, throughout this description. In this description, excluding definitions, claims and abstract, wherever ‘Variable Character Set’ is written, it is to be read as ‘Variable Character Set/Sub Variable Character Set of any level’ and ‘VCS’ is to be read as ‘VCS/SVCS of any level’ unless the context indicates other wise. Similarly wherever ‘Encryption Key’ is written, it is to be read as Encryption key having same characters as Password/Encryption key padded by preagreed padding algorithm unless the context indicates otherwise. of USER, Human USER, USER object, SERVICE PROVIDER, Call Response, Number of ances, Chance of Breach and Password Safety Index do not require further elaboration, as meanings a obvious from the definitions. ilaterally Generated Encryption Key System: e Bilaterally Generated Encryption Key System is a system that integrates functions of authentication d securing of transactions, providing passwords simultaneously useable as symmetric encryption ys with or without addition of additional characters. The system secures, each one of the transaction tiated by USERs and each one of the object exchanged in transactions by separate keys. The system vides two different computationally non-intensive, symmetric encryption keys linked with USER's ntity to each one of the transactions. The keys are not pre-formed but generated at the instant of insaction. The keys are not exchanged. Since multitude of keys could be generated simultaneously or quick succession using the system and an authentication device, the problem of key changing and y management with large number of service providers and USERs is eliminated. The keys are shorter an the keys of DES/AES, with use of font/distinguishing property variation on characters. The system IS wide adaptability to all uses of encryption. The advantage of the system is that even the inverse ys are a set of random numbers and when unexposed, are used as encryption keys to secure insactions and objects exchanged in transactions. The authentication and securing of individual insactions is done for known USERs, as well as previously unknown USERs. The system provides a mputationally non-intensive means of tracing objects to the originator. The system dispenses with amorisation. BIGENK system uses the Variable Character Set System of authentication devices along th repeated variation of font/distinguishing properties and Transformation of CUs/BCs. The system compasses the key generation process including padding of keys, the system and interface programs ecutable by SERVICE PROVIDER/USER systems. The system is capable of generating two types of icryption keys namely Bilaterally Generated Encryption Keys and Non Repeating Bilaterally nerated Encryption Keys. e system is designed to generate plurality of Passwords/Encryption keys, from single initially nished Password, relieving USER from further input. Generating multiple Passwords/Encryption keys im single initially furnished Password, is a special method of the present invention, adopted to relieve ERs from furnishing many Passwords/Encryption keys required to authenticate and secure each insaction. The system is designed to secure every individual transaction of Previously Unknown ERs by using a temporary authentication device. e system is designed to perform a number of authentication and transaction security based tasks, ich include, but not limited to: Two way authentication and securing by encryption of each and every individual Internet Contract Network transactions of USER with different Passwords/encryption keys, furnished by a USER separately for each transaction, inclusive of objects exchanged between USER and SERVICE PROVIDER using one Password furnished by USER and one system generated, as Passwords/encryption keys for each transaction, including maintaining link between USER and SERVICE PROVIDER from beginning to end of session.
2) Two way authentication and securing by encryption of each and every individual Internet/Network transaction inclusive of objects exchanged, by different variable Passwords/encryption keys with just one Password furnished by a USER at the beginning of a session, using a specially designed USER Agent Software, by using two system generated Passwords/encryption keys for each transaction including maintaining link between USERs and SERVICE PROVIDERs from beginning to end of session and providing proof for all transactions of USER.
3) Two way authentication and securing by encryption of each and every individual Internet/Network transaction inclusive of objects exchanged of a previously unknown USER with different Passwords/encryption keys, generating said different Passwords/encryption keys from one Password furnished from a temporary authentication device, by previously unknown USER at the beginning of a session using a specially designed USER Agent Software using two system generated Passwords/encryption keys for each transaction including maintaining link between previously unknown USERs and SERVICE PROVIDERs from beginning to end of session and providing proof for all transactions of previously unknown USER.

To appreciate the invention properly, the disclosure is arranged in the following order: the system of authentication devices, the key generation process including padding of keys, two types of Encryption keys generated, methods used in authentication/securing, advantageous effects of the invention, modes of carrying out the invention and industrial applicability.

Variable Character Set System of authentication devices: In Bilaterally Generated Encryption Key System, the Variable Character Set System of authentication devices are used as means of generating Passwords/Encryption keys by authorised USERs and as means of verifying the Passwords/Encryption keys by SERVICE PROVIDERs providing access and service to the USERs. They are:
1) Variable Character Sets (VCS)
2) Master Variable Character Sets (MVCS)
3) Sub Variable Character Sets (SVCS)
4) Sub Variable Character Sets of Level 2 or below (SVCSL2, SVCSL3 . . . )

The system has the following subsystems:
1) VCS for both SERVICE PROVIDER and USER.
2) MVCS with a SVCS expressed in brief form for SERVICE PROVIDER and a SVCS for USER.
3) MVCS with a SVCSL2 or below expressed in brief form for SERVICE PROVIDER and SVCSL2 or below for USER.

Any one of the three subsystems is used according to choice of SERVICE PROVIDER or the type of use. All the authentication device mentioned above comprise of an arrangement of a plurality of Character Units (CUs) in which the CUs are identified using unique Serial Number of Character Units (SNCUs). The arrangement is designed to obtain different variable Passwords/Encryption keys formed of all permutations of a selected number of CUs in which the CUs could repeat within a Password/Encryption key. The CUs consist of either one Basic Character (BC) or a permutation of more than one BC.

Basic Character: The basic elements of VCS are the characters used to form CUs. Hence, they are called Basic Characters (BCs). They are single characters selected from any type of characters like Alphabets, Numbers and Symbols of any language or script or number or symbol systems identifiable by USER and SERVICE PROVIDER, with or without any font/distinguishing property such as font type, font size, font colour, Underlined, Bold, Italics, etc. Any representation of objects like diagrams, drawings, images, photos, pictures, sketches, identified as distinct units, with or without any distinguishing property identifiable by USER and SERVICE PROVIDER such as size, colour patterns, shading, Underlined, etc, are also used as BCs.

BIGENK System recognises each of the characters distinctly based on font/distinguishing properties of characters. Each BC is formed in a calculated number of ways, which is the product of the number of characters used, and number of each one of the font/distinguishing properties used. If 20 font colours, font types, 10 font sizes, Underlined/Non underlined characters are used, a single BC is formed in 20×20×10×2=8000 ways. Without font/distinguishing property variation, it is only one way. Human USERs could recognise some variations in font/distinguishing properties like font colours, Underlined characters easily. Human USERs, only with prior knowledge, could recognise/do variation in font types, Italics, Bold, and font sizes. Some of the font types are written similar to Italics. Large font size is undifferentiated, whether it is Bold or otherwise. Therefore, font/distinguishing properties, which are difficult to recognise, is brought to the prior knowledge of Human USERs. Alternatively, these font/distinguishing properties are chosen by Human USERs; for example, in a Password/Encryption key, the first character's font type is set to Arial, second character's size is set to 16, third character's is Bold, fourth character is in Italics, or all CUs in the first row will have Arial font, all CUs in the second row will be of size 16, etc. USER objects are able to recognise any font/distinguishing property variations, when programmed and hence use of font/distinguishing property variations is unrestricted and the allowable variation is much larger. Differentiation based on font/distinguishing property variations in non-computer systems like cameras, mobile phones, etc is usable when such hardware are able to differentiate between same characters based on font/distinguishing property. The differentiation based on font/distinguishing property variations is done to the extent the USER/SERVICE PROVIDER are able to recognise and use.

USERs without being conversant with a language or number system, use characters from that language or number system, as CUs are seen from VCS and furnished by Human USERs. Scroll/drop down menus, which are unrestricted by any character selection algorithm for choosing characters and changing the font/distinguishing properties and offer freedom to select any character/font/distinguishing properties, facilitate Human USERs to furnish the BCs, easily. For USER objects, recognition of any type of character or font/distinguishing properties is programmable. Since forming of CUs is random process, some of the BCs that were originally used to generate CUs are feasibly excluded, from all the CU of a VCS. Even if a few BCs are feasibly excluded in the CUs of a VCS, still for calculation of chance of breach and PSI, the number of BCs used initially to generate CUs only is taken in to account. The total number of BCs required is decided to ensure the number of permutations of BCs forming unique CUs and number of permutations of CUs forming unique VCSs are sufficient to cover the safety requirements of Passwords/Encryption keys and the requirement of unique VCSs for all USERs of a SERVICE PROVIDER. The BCs are selected directly from characters with or without font/distinguishing properties or indirectly by selecting characters and selecting font/distinguishing properties separately and arriving at every possible combination of each of the characters and each of the font/distinguishing properties. This completes selection of BCs. The following is to be taken care: When using numbers and alphabets as BCs, every BC is to be written or printed in unique way and there is no confusion in reading from the VCS. The characters: C, c, I, l, 1, K, k, o, O, 0, P, p, S, s, U, u, V, v, W, w, X, x, Y, y, Z and z, are a few, which could be wrongly read.

Example of BCs: A, e, 1, 9, &, @, $, A, e, 1, 9, &, @, $, A, e, 1, 9, &, @, $. Even though same set of Characters are shown 3 times, they are differentiated based on font/distinguishing properties ((Arial font, 10 size, Black, Bold), (Times New Roman font, 12 size, Grey-80%, Italics), (Courier New font, 11 size, Grey-50%, Underlined)) and hence each BC is unique. Examples for font property variations of BCs are given in VCS 5 to VCS 6. Use of large number of BCs with characters from 3 languages, 2 number systems, symbols and pictures to give an idea of possible variations of BCs is shown in VCS 6.

Character Unit (CU): CUs provide variability to Passwords/Encryption keys. It is the basic unit of VCS made of only one BC or a permutation of more than one BC. It is any random permutation of any type of BCs. The advantage of multiple character CUs is that USER has to refer to VCS to get CUs less frequently as compared to single character CUs; (for 6 characters Encryption key, in case of single character CU, USER has to refer to VCS, 6 times but with 2 BCs per CU, USER has to refer to VCS, only 3 times). Higher the number of BCs per CU, higher is the number of possible ways of forming CUs and number of possible ways of forming unique VCSs. Generally, CUs in a VCS have a fixed number of BCs. However, it is permissible to use a limited number of CUs (up to 10%) with less number of BCs per CU, i.e. in a VCS, which has mostly CUs of 3 BCs, it is allowed to use CUs of single or 2 BCs up to 10% of total number of CUs. This method further enhances variability of CUs. VCS 2 and VCS 4, illustrate this.

Method of generation of CU: The steps are: BCs and the number of BCs per CU are selected in a way convenient to USER to read and reproduce at the time of Password/Encryption key generation. The number of CUs in a VCS is selected, ensuring the resulting number of permutations of CUs forming unique VCSs and the total number of Passwords/Encryption keys generated from the VCS meets the requirement of USER and SERVICE PROVIDER. The mathematical relationship between BCs, CUs, VCS, Passwords/Encryption keys and PSI is taken in to account in selection of BCs and BCs per CU. The CUs are generated by random choice of single BC-CUs or random permutation of multiple BC-CUs using all the BCs selected. The random permutation includes repeating a BC within same CU.

For example, say: A to Z, without font/distinguishing property variations are chosen as BCs. Each BC is assigned a serial number (say 1=A, 2=B, 26=Z). The number of BCs per CU is decided. Using a program, random numbers within the total number of BCs are generated (say 24, 3, 13, 7, 19, 5, 22, 1, 9, 9 etc.) For single BC-CUs, the random numbers are replaced with BC corresponding to the assigned serial number, which become the CUs (for above serial numbers, the CUs are X, C, M, G. S, A, I, l, etc.). Two, single BC-CUs as obtained in previous step are combined to get 2 BC-CUs (for above serial numbers, the CUs are XC, MG, SA, I l, etc.). Similarly any number of CUs with any number of BCs per CU is formed. Examples: 7, D, 43, Sf, 1A$, 927, sR6@, a7B8*, 7. D, 43. Sf, 1A$, 927, sR6@, a7B8*. Even though, same characters or character strings are shown, 2 times in the above example, they are differentiated based on font/distinguishing properties and hence each of the above CU is unique. For more examples of CUs, VCS 1 to VCS 6 may be referred to.

Variable Character Set (VCS): It is a list or table or array or matrix, which contains CUs. It is generated either by USER or by SERVICE PROVIDER. It is known only to USER and SERVICE PROVIDER. VCS has a large number of CUs. Each CU is identified by a unique serial number of CU (SNCU). For USERs to generate CUs/VCS, SERVICE PROVIDER specifies rules or USERs combine BCs in any manner, which is validated for randomness and accepted by SERVICE PROVIDER. If VCS is in rows and columns, SNCUs have to be assigned in a manner, which facilitates easy identification/calculation by USER for USER to read CUs corresponding to SNCUs. In VCSs, no relation ship exists between CUs and SNCUs. Similarly no relationship exists among the CUs, because CUs are randomly generated. Non existence of such relationships, prevent shoulder surfers from extrapolating other CUs. VCS are very simple such as VCS 1 to VCS 4 or complex such as VCS 5 and VCS 6. The choice of complexity of VCS is to be decided by SERVICE PROVIDERs according to the requirements and preference of Human USERs. If a VCS is safeguarded, it is useable for a very long time without replacement. Also, creation of VCS is a simple process, even if there is a need for replacement. VCS, which is used to generate a million or more Passwords/Encryption keys, is printed in a paper or card of size similar to a credit card. VCS also is kept in encrypted file form.

Method of generation of VCS: The number of CUs, in a VCS is decided based on requirements of USERs, the type of Encryption keys (Repeating or Non Repeating), the number of CUs in a Password/encryption key and PSI. The CUs, generated by following method given under Method of generation of CUs, are arranged sequentially or randomly. The required number of CUs are arranged to any one of the form of list or table or array or matrix suitable to USER to get VCS. Each CU is assigned a unique serial number. The method of identifying/calculating the serial number also is specified.

Examples of VCS, viz: VCS 1 to VCS 6 are given in FIG. 1 to 3. VCS 1 to VCS 4 are simpler type. VCS 5 shows font/distinguishing property variations of characters. VCS 6 is made of characters from 3 languages, 2 number systems, a number of symbols and pictures to show possible variations of VCSs.

Master Variable Character Set (MVCS): It is a large VCS defined for use in a system as the Master Variable Character Set, which contains all the Sub Variable Character Sets (SVCS). Many VCS are derived from MVCS. The VCSs derived from MVCS are called SVCS. In case, USERs are allowed to create, SVCSs of their choice, then, MVCS is generated as combined, continuous and non-overlapping list of all SVCSs of all USERs in a system. MVCS is used as the principal authentication device for all USERs in combination with SVCSs, as means of generating encryption keys in the BIGENK system as an alternative to individual VCSs, conferring substantial advantage to SERVICE PROVIDERs.

Method of generation of MVCS: The number of CUs are decided considering the requirements of all USERs, USER groups, the type of encryption keys (Repeating or Non Repeating), the number of CUs per encryption key and PSI desired. It is generated following the same method of generation of VCS, except that large numbers of CUs are used. In case, USERs are allowed to create, the SVCSs, then, MVCS is generated as combined, continuous and non-overlapping list of all SVCSs of all the USERs in a system. Example: MVCS 1 is given in FIG. 4.

Sub Variable Character Set (SVCS): SVCSs are used in combination with MVCS, as means of generating encryption keys in the BIGENK System as an alternative to individual VCSs, which confer substantial advantage to SERVICE PROVIDERs. They are identified for use by any one USER or any one category of USERs and are derived from MVCS if generated by SERVICE PROVIDER. Each SVCS has any number of CUs of MVCS arranged in any order. SERVICE PROVIDER defines the rules for framing SVCSs in terms of SNCUs of MVCS, similar to criteria for filtering records of a data table. In addition, discrete, continuous or random sequences of CUs of MVCS are used to form SVCS. SVCS have a few mutually non-exclusive CUs. The extent of non-exclusive CUs is limited in order that no specific relationship is established, between CUs of two SVCSs by comparing SVCSs of same origin. This way a large number of SVCSs are formed out of one MVCS. CUs are selected from MVCS, as given here and arranged in to get a SVCS. These rules are also programmed to get SVCSs. The CUs of SVCSs are assigned SNCUs independent of SNCUs of MVCS. A Serial number/identification number is assigned to each SVCS. Prefixing or suffixing identification number of the SVCS of MVCS with Encryption key is used to identify any Encryption key specific to a particular SVCS of the MVCS. In case, USERs are allowed to create, SVCSs, USERs create it in the same manner of creation of VCS. For USERs, there is no difference between individual VCS and SVCS functionally. SERVICE PROVIDER maintaining separate SVCSs in complete form is dispensed with. SVCS as a list of SNCUs of MVCS is only to be maintained. SERVICE PROVIDER specifies rules of framing SVCS in terms of SNCUs of MVCS or specifies only the SNCUs of MVCS for each SVCS. When SVCS is specified by rules, it is briefer than a VCS of equal size, exception being small SVCSs with too few CUs. When SVCS is specified by SNCUs of MVCS, it is mostly in sequences and each of such sequence is briefly indicated by just 2 SNCUs; In both cases SVCS are represented by unique SNCUs of MVCS, more briefly than a VCS of same number of CUs, exception being small SVCSs with too few CUs. USERs are given complete SVCS. The Encryption key calls are in SNCUs of SVCS. When validating Encryption keys, the validating program compares with CUs of MVCS corresponding to the SNCUs of SVCS. Even if a SVCS is compromised or physically stolen, the MVCS is still unchanged and another SVCS is made out of the MVCS.

### Example of Specifying SVCS by Rules

a) All CUs of MVCS, whose SNCUs are between 57 and 157 and are of even number,
b) All CUs of MVCS, whose SNCUs are between 39 and 88 and written in descending order,
c) All CUs of MVCS, whose SNCUs are between 47 and 295 and Modulus (SNCU, 5)=3, etc.

Example of generation of SVCS and Specifying SVCS by SNCUs of MVCS: MVCS 1 has been used to generate a few 50 CU, SVCS in the following manner:

| SVCS | | Number of SNCUs, |
|---|---|---|
| Identification | SNCUs forming SVCS | which represent SVCS |
| AA | 1 to 50 | 2 |
| AB | 46 to 95 | 2 |
| AC | 91 to 140 | 2 |
| AD | 136 to 185 | 2 |
| AE | 181 to 231 | 2 |
| AF | 226 to 275 | 2 |
| AG | 271 to 300, 1 to 5, 75 to 80, | 8 |
| | 130 to 137, 49, 167 | |
| AH | 183 to 192, 27 to 36, 254 to 263, | 10 |
| | 130 to 139, 75 to 84 | |

And so on i.e.: many more are created. From the above examples it is inferred that SVCS is represented in a briefer way than a VCS of same number of CUs. It is also inferred that many SVCSs are derived from one MVCS with less than proportionate number of CUs required for all the SVCSs. The 8 SVCS shown in the example are shortly, represented by a total of 30 SNCUs of MVCS. Instead of storing 8×50=400 CUs, only 300 CUs and 30 SNCUs need be stored, which shows the possible reduction of data storage. With many more possible SVCSs, the high advantage of using MVCS/SVCS arrangement is obvious.

Sub Variable Character Set of Level 2 or below (SVCSL2, SVCSL3 . . . ): SVCSs of level 2 or below are also used in combination with MVCS, as means of generating encryption keys in the BIGENK system as an alternative to individual VCSs, which confer substantial advantage to SERVICE PROVIDERs. It is further derivation from SVCS identified for use by any one-subgroup USER or any one-subgroup category of USERs. This way large number of USERs with subgroup and subgroup of subgroups are formed. SVCSs of level 2 or below are derived from one level up SVCS and are any combination of parts of one level up SVCS. For SERVICE PROVIDERs, deriving SVCS of level 2 or below from one level up SVCS is similar to deriving SVCS from MVCS. USERs optionally select randomly, the required number of CUs, out of CUs of one level up SVCS provided by SERVICE PROVIDERs. SERVICE PROVIDER maintaining separate SVCS of level 2 or below in complete form is dispensed with. SVCS of level 2 or below as a list of SNCUs of MVCS is only to be maintained. SERVICE PROVIDER specify rules of framing SVCS of level 2 or below in terms of SNCUs of MVCS or only SNCUs of MVCS for each SVCS of level 2 or below. When SVCS of level 2 or below is specified by rules, it is briefer than a VCS of equal size, exception being small SVCSs of level 2 or below with too few CUs. When SVCS of level 2 or below is specified by SNCUs of MVCS, it is in sequences and each of such sequence are briefly indicated by just 2 SNCUs; In both cases a SVCS of level 2 or below are represented by unique SNCUs of MVCS, more briefly than a VCS of same number of CUs, except for small SVCSs of level 2 or below with too few CUs. USERs are given complete SVCS of level 2 or below. The Encryption key calls are in SNCUs of SVCS of level 2 or below. When validating Encryption keys, the validating program compares with CUs of MVCS corresponding to the SNCUs of SVCS of level 2 or below. Even if a SVCS of level 2 or below is compromised or physically stolen the MVCS/one level up SVCS is still unchanged and another SVCS of level 2 or below is made out of the one level up SVCS.

Combined Use of MVCS and SVCSs: A SERVICE PROVIDER, having large number of USERs, instead of registering large number of VCSs, at the rate of one per USER, registers one MVCS in his system and defines the rules for framing as many SVCSs required or specify only SNCUs of MVCS for each SVCS. As shown in the examples given above, many SVCSs are derived from one MVCS with less than proportionate number of CUs required for all the SVCSs. SERVICE PROVIDER maintaining separate SVCSs in complete form is dispensed with. SVCS as a list of SNCUs of MVCS is only to be maintained. Unique SNCUs of MVCS represent SVCS, more briefly than a VCS of same number of CUs, exception being small SVCSs with too few CUs. Therefore reduction of data storage from many VCS to one MVCS and as many SVCS represented briefly, is obtained by combined use of MVCS and SVCSs. SNCUs of separate VCSs are diverse, their referral, calling the values in to software programs etc., have to be different for each VCS. SNCUs of MVCS representing the SVCSs are unique. Referral, calling the values in to software programs etc., is same for all SVCSs. Each VCS also have to be defined in the software programs separately, devoting a few lines for each VCS. When SVCSs are used, this is dispensed with. This facilitates easy identification of SNCUs or CUs of SVCSs, in software programs, with fewer lines of programs. It also is necessary for classification of USERs on access. Even when, USERs are allowed to create, SVCSs, MVCS/SVCSs arrangement is used so that facility of easy identification in programs and automatic classification of USERs on access is still available and data storage is only slightly increased. MVCS/SVCS arrangement is useful when separate identity and authentication is required to access specific sub domains within a domain. MVCS/SVCS arrangement is convenient for short time use spanning a session, in authentication of USER initiated actions/objects, linking with the identity of USERs. MVCS/SVCS arrangement provides advantage and convenience to SERVICE PROVIDER. However, Use of individual VCS or MVCS/SVCS arrangement is optional.

Combined Use of MVCS and SVCS of level 2 or below: Use of MVCS and SVCS of level 2 or below is similar to use of MVCS/SVCS and confers similar advantages, but for lower reduction in data storage.

Transformation of Variable Character Set: It is an optional method, for deriving new CUs of VCSs instantly at the time of Response to a Call, by operating any rule or rules on a VCS by which the original CUs of a VCS becomes transformed to new CUs. This is used to secure VCS against theft or compromise, similar to varying font/distinguishing properties. Transformations are done on CUs or BCs. Few examples of rules of transformation are given below, using VCS1 as original VCS: SNCU of VCS (Transformed)=SNCU of VCS (Original)+27, for all SNCUs. Applying this rule on VCS1 SNCUs of transformed VCS are {28, 29, 30, 31 . . . 97, 98, 99, 100, 1, 2, 3, 4 . . . 24, 25, 26, 27 of VCS1} SNCU of VCS (Transformed)=(SNCU of VCS (Original)−10) for all SNCUs. Applying this rule on VCS1 SNCUs of transformed VCS are {91, 92 . . . 99, 100, 1, 2, 3, 4 . . . 87, 88, 89, 90 of VCS1}

When the SNCU of transformed VCS after operating the rule becomes negative, the total number of SNCUs of the original VCS has to be added to the figure to obtain the transformed SNCU. When it exceeds the total number of SNCUs of the original VCS, then the total number of SNCUs of the original VCS has to be deducted to the figure to obtain the transformed SNCU.

Transformation is also done on BCs. In this, the BCs are transformed by rules such as all ‘A’s are transformed to ‘E’, all ‘B’s are transformed to ‘F’, all ‘C’s are transformed to ‘G’, etc.

For higher security, rules that are more complex or combination of rules are applied. The rules are changed at any time. Similar to font/distinguishing property variations, the transformation rules have to be registered with SERVICE PROVIDER and kept separately from original VCS. Willing USER memorises the transformation rules. At the time of Response, USERs have to furnish CUs of transformed VCS from the original VCS by operating the pre-registered rules. Transformation rules are also specified by SERVICE PROVIDERs to be followed by USERs. Transformation is an additional safety measure, is used as a supplement to font/distinguishing property variation or independently.

Key Generation Process: The process checks, “what the user has” to establish the authenticity. The USER and SERVICE PROVIDER use a pre agreed authentication device of VCS system of authentication devices, to generate Passwords/Encryption keys. The Encryption key comprises of a permutation of selected number of CUs of the authentication device. Optionally same CUs are repeated in Encryption key. When a USER wants to initiate a transaction with a SERVICE PROVIDER, the USER approaches the SERVICE PROVIDER by opening the website or dialogue window or simply switching on a system. The SERVICE PROVIDER asks the USER to furnish the USER name or identification number such as credit card number. If USER name or identification number is unregistered, SERVICE PROVIDER reminds the USER to furnish correct USER Name and denies access after few chances. SERVICE PROVIDER after verifying USER name and referring to the pre agreed VCS for the particular USER, generates a specified number of random numbers each of which is equal to or less than the total number of CUs in the VCS and validates the random numbers for predetermined rules, such as non-repetition of random numbers. SERVICE PROVIDER then transmits the generated random numbers to USER, which is termed as a Call. The USER understands that these random numbers are SNCUs of the pre agreed VCS and USER has been called to furnish CUs corresponding to the called SNCUs, which is the Encryption key for that transaction. USER's Response to this Call is by furnishing CUs whose SNCUs are the random numbers of Call, in the order of Call. The Encryption key is furnished as a continuous string of CUs, combining all CUs of Encryption keys with BCs indistinguishable as belonging to particular CU of the authentication device. A Call could include identification number of a Sub Variable Character Set of any level. When Call includes identification number of a Sub Variable Character Set of any level, the Response also includes identification number of that Sub Variable Character Set of any level. The SERVICE PROVIDER verifies that each CU/SVCS Identification number furnished by the USER is correct and matches exactly as per the pre agreed VCS corresponding to the Call. When it is matched, the USER is authenticated and the key furnished is validated. Otherwise, the USER is given a few more chances to furnish the correct Encryption key. When USER fails, to furnish the correct Encryption key within given chances, the transaction is aborted and subsequent attempt to take place only after specified time and the USER is to furnish 2 Encryption keys successively or equivalent stronger Encryption key, entered in first chance itself to proceed with transactions. In case the USER is unable to furnish Encryption key in a double Encryption key Call or double strength Encryption key Call at first chance, the USER is denied access until USER establishes his authenticity to the satisfaction of the SERVICE PROVIDER through other means.

When the USER and SERVICE PROVIDER are in session, incorrect response fails as detailed above. When the USER and SERVICE PROVIDER are not in session and a USER attempts to open an encrypted message such as a saved message, system is designed to reject after allowing specified number of chances, noting the date, time of rejection, and no further attempts are allowed. For this purpose, the system creates a file having failed attempt data in the USER's system, created only if there is a failure; such file's access is restricted to particular encrypted message by a strong password. Whenever a USER not in session, attempts to open an encrypted message the decrypting system looks for file having failed attempt data in the main drive of USER's system. If such file is not there, user is allowed specified number of chances. If USER fails, the file is created in the USER's system. USER must furnish password to delete the file. The password is not related to the VCS of USER or encryption key and only could be obtained from SERVICE PROVIDER to recover the message. Recovery of such message shall be effected in the following manner: SERVICE PROVIDER sends the password to delete the file having failed attempt data. After deleting this file, USER is allowed to furnish key again, referring to VCS. If unauthorised persons attempts at the password for deleting the file he/she might have to do thousands of times to breach the password first and then attempt at the encryption key. If unauthorised persons attempts use another system to decrypt, he/she has to use thousands of systems to breach the encryption key. After such enormous efforts, even if one succeeds, the particular message only is seen and there is no further use of the encryption key. By this provision, unauthorised persons breach attempts are effectively prevented.

Example of an authentication/key generation dialogue in Internet, between a USER, say USER1 and SERVICE PROVIDER say SP1, (who have pre agreed on VCS1) is given below:

USER1 has opened the website of SP1, indicating his desire to do transaction and approached SP1.
SP1: Please enter your USER name
USER1: USER1
SP1: 70, 31, 43
USER1: @xlmrA
SP1: Welcome “USER1” (Welcome implies that USER1 has furnished the correct Password/Encryption keys)

Example of an authentication/key generation dialogue in Internet between USER1 and SP1 when USER1 commits mistakes in furnishing CUs, rejected after 3 chances and after specified time reattempts:
USER1 has opened the website of SP1
SP1: Please enter your USER name
USER1: USER1
SP1: 4, 100, 43
USER1: ZADJRA
SP1: The Encryption key you furnished is incorrect. Please enter the correct Encryption key for 4, 100, 43
USER1: zadjra
SP1: The Encryption key you furnished is incorrect. Please enter correct Encryption key for 4, 100, 43.
   Reminder: Last Try.
USER1: ZaDjRa
SP1: Sorry. You have furnished incorrect Encryption keys thrice. ACCESS DENIED. You may retry after 2 hours.
   USER1 after 2 hours has opened the website of SP1.
SP1: Please enter your USER name
USER1: USER1
SP1: 71, 34, 85, 29, 96, 52. Reminder: Only one chance is allowed.
USER1: FmOvclwlb1xP
SP1: Welcome “USER1” (Welcome implies that USER1 has furnished the correct Encryption key)

Thus an Encryption key is formed in an easy manner, using simple means of VCS. The Encryption keys are variable based on combination of random numbers for every transaction. They are also generated just at the instant of transaction.

Bilaterally Generated Encryption Keys: It is an Encryption Key, generated using the BIGENK System. In BIGENKs, any CU is called repeatedly; i.e. any SNCU that has been called previously for an Encryption key is called repeatedly for subsequent Encryption keys without any restriction. BIGENKs repeat rarely. When VCS1 is used, on a 6-character Encryption keys chance of repetition is 1 in a million. Chance of repeating an Encryption key is equal to that of any other variable Password of same Basic Characters. Therefore, it remains unused even when stolen, as none could predict, when the same Encryption keys will be called for, again. Repeated variation of font/distinguishing properties of VCS/Transformation of VCS is done optionally at any time and any number of times after the VCS is issued.

Method of generation of BIGENK: SERVICE PROVIDER's program, calls for random numbers within the total number of CUs of the VCS and validates the random numbers for predetermined rules specified. After furnishing of BIGENK by USER, it compares, admits or rejects BIGENK. It limits the number of chances and Call for two BIGENK successively/stronger Encryption keys, when there is a failure from USER to furnish Encryption keys within specified number of chances. It also furnishes report of all Encryption keys calls with time and failed attempts. It validates and accepts font/distinguishing property variations/Transformations done by USER.

Non-Repeating Bilateraly Generated Encryption Key (NRBIGENK): It is an Encryption key, generated using the BIGENK system in which no Encryption keys repeats. In a BIGENK, any CU that has been called previously for an Encryption key is called again for subsequent Encryption keys without any restriction. In a NRBIGENK, there is some restriction on calling CUs repeatedly. In each Call of NRBIGENK, a fixed number of CUs (say 2 out of 3 CUs) have to be called for the first time. The balance (say 1 out of 3) only to be repeated. In case SVCS identification is required, it is also called for, along with CUs similar to BIGENK. It is to prevent spying for CUs. With NRBIGENKs, even when some body knows a number of CUs of the VCS of a USER, still will be unable to furnish the Encryption keys. These Encryption keys are used up before anybody attempts to steal. Thus, NRBIGENK is a still more secure Encryption keys. Font/distinguishing property variations are effected/Transformation is done in NRBIGENK also, after issue of VCS. The VCS exhausts as and when the last CU that has to be called for the first time is called. After Font/distinguishing property variations/Transformation, the CUs/VCS become new.

Method of generation of NRBIGENK: SERVICE PROVIDER's program is similar to BIGENK with following additions: It maintains a list of already called SNCUs against each VCS, compares/limits the SNCUs to be repeatedly called and Calls for random serial numbers from the yet to be called list. It reports well in time, the exhausting of VCS so that replacement is arranged or USER is prompted to vary font/distinguishing properties of CUs/Transformation of VCS.

Padding of keys: BIGENKs are stronger than existing encryption key systems, requiring less number of characters per key. However, the system uses variable length encryption keys generated from single encryption key during a session, which are short. To provide for generating any required number of characters for a given encryption key, padding is required. Padding of the keys is the process of addition of characters to the user furnished encryption key to make keys with required number of characters. When font/distinguishing properties are not used in the BCs, 8 to 32 characters are required for a key. Even though BIGENK system of authentication devices could produce any required number of characters by calling corresponding number of CUs, it is still proposed to reduce the USER's efforts by providing a method of addition of characters as follows:

The number of characters of Password is known to the user, from which the required number of padding characters are calculated. The BCs of Password/Encryption key are converted to the assigned serial number, when forming the VCS. These are random numbers say Rᵢ. The geometric mean of these random numbers say ‘M’ is calculated. If ‘M’ is a round number, ‘M’ is multiplied by the constant ‘π’ and the result is taken as ‘M’. If ‘M’ is not a round number, then the decimal characters are extracted from ‘M’, which is the seed ‘S₀’. Any mathematical or statistical function such as Fishers Number, Standard normal cumulative distribution, (see below for formulae), logarithm, etc that takes a single input value and gives an output value is operated on ‘S₀’.

Fisher Number of x=0.5 logₑ((1+x)/(1−x)) (−x²/2).
Standard normal cumulative distribution of x=(1/√(2*π))*e

The decimal characters are extracted from the output value, which is S₁. The random numbers Rᵢ are then split to single digits say d₁, d₂, d₃ . . . dᵢ etc. One or more characters to be padded pᵢ is selected from each of one of the output value Sᵢ, corresponding to the position of characters of dᵢ; say for pᵢ to p₄, the characters occurring at ‘d₁+1’ th position to d₁+1+4 th position of S₁ is selected. Then S₁ is again operated with mathematical or statistical function, the decimal characters are extracted to get S₂. p₅ to p₈ are the numbers occurring at ‘d₂+1’ th position to d₂+1+4 th position of S₂. If the first few digits of Sᵢ are 0 then Sᵢ is multiplied by 10/100/1000 etc, to make Sᵢ is equal to or more than 0.1.

The padding characters are added to password in the following manner. If d₁ is even number, p₁ to p₄ will be first 4 characters of Encryption key. Followed by one CU. If d₁ is odd then CU will be first followed by p₁ to p₄. The same criterion is followed until all CUs of Password exhausted. Then all remaining padding characters are appended to the string so obtained.

An example is given below to explain the concept clearly for the first example of Password ‘@xlmrA’, using Fisher number as character generating function: If 24 characters are required for encryption key, number of characters required for padding is 24−6=18, In VCS 1, A to Z, a to z, 0 to 9, @, $ in order have been assigned serial numbers from 1 to 64.

The Rᵢ are 63, 50, 38, 39, 44, 1; M=24.29043201569940; S₀=0.29043201569940; Fisher Number of S₀=S₁=0.2990380125784810; d1=6; p₁ to p₄=0125 S₂=0.3084628099253110; d₂=3; p₅ to p₈=4628 S₃=0.3188456841256790; d₃=5; p₉ to p₁₂=5684 S₄=0.3303616344624050; d₄=0; p₁₃ to p₁₆=3303 S₅=0.3432341380650000; d₅=3; p₁₇ to p₁₈=23

Since d₁ is even, d₂, d₃ are odd and only 3 CUs are in the Password the following is the padded encryption key:

0125 @xlm 4628 rA56 8433 0323.

The algorithm for padding is a matter of prior agreement between users. The padding process is done by the software and user is not required to do any calculation in this aspect. The padding algorithm above uses data from the Password but does not reveal any thing related to VCS. By this method, even though numbers only are used, the position occurrence of numeric character is varied on par with characters of password making the encryption key as strong as the one, which is directly made from VCS. The same method is used for padding calls also, taking the password corresponding to the call for generating numbers. However to provide variability between padding keys of Password and that of call, the following changes are done: Instead of geometric mean, harmonic mean is used when generating ‘M’. One or two but not all, the CUs of the password, is/are added following the above given procedure.

The USER is required to furnish only the unpadded key as obtainable from VCS. The software is designed to pad the keys as per the choice of algorithm made by USER and furnish for encryption/decryption.

### Methods Used in Securing Transactions:

Generating multiple Encryption keys from one Password/encryption key: This is a special method designed to relieve USERs from furnishing many Passwords/Encryption keys for securing every transaction. The authentication device has same number of BCs per CU for all CUs to facilitate identification of CUs directly from Password/Encryption key. The Call is for a minimum of 4 CUs to ensure that at least 60 unique BIGENKs are formed out of SVCS/SVCS L2, using 2 CU, 3 CU and 4 CU calls with different permutations at random. The method of generating multiple Encryption keys from single Password/Encryption keys uses an USER Agent Software. The USER Agent Software collects the Call and Password/Encryption keys for initial access from USER. From the Call and Password/Encryption key, number of CUs in the Password/Encryption key and CUs are determined. USER Agent Software then forms a SVCS of any Level, using all CUs as obtained above. Then it assigns SNCUs. SNCUs so assigned need not be continuous and preferably having 2 or more digits to facilitate higher variability. For example: 304, 427, 550, 673, 796 . . . etc, are useable as serial numbers. SNCUs are communicated to SERVICE PROVIDER using the Password/Encryption keys as obtained above as encryption key. When the first unexposed Call is used as SNCUs, the assignment of SNCUs and communication is avoided. The same procedure is adopted for temporary SVCS also. The SVCS of any level, so formed by USER Agent Software is used as the authentication device of that session. All Calls are made within the authentication device of that session. An example of this method is given below using VCS 3.

SERVICE PROVIDER's Call: 17 51, 133, 27, 150, 48, 44
USER's Response (Encryption key): AmRQ5o

| | | | | | | | |
|---|---|---|---|---|---|---|---|
| SVCS formed | SNCU | 16 | 37 | 58 | 79 | 100 | 121 |
| | CU | A | m | R | Q | 5 | o |

The SNCUs are assigned here independently and communicated to SERVICE PROVIDER. When SERVICE PROVIDER's Call is unexposed, then 51, 133, 27, 150, 48, 44 are useable as SNCUs.

Example of Calls within SVCS: (i) 79, 16, 58, 100 (ii) 121, 37, 16 (iii) 79, 37 (iv) 16, 58, 100, 79, 121, 37

Responses: (i) QAR5 (ii) omA (iii) Qm (iv) AR5Qom

The above SVCS is capable of providing 1950 unique Encryption keys. Additional 1949 unexposed Calls are also available to secure objects exchanged in the transactions, making 3899 encryption keys from this SVCS.

USER Agent Software: USER Agent Software is a specially designed software, representing USER and transacting with SERVICE PROVIDER. It is integrated with Internet Contract/Network Transaction software or used as independent software. It functions from USER's system to perform authentication/securing of individual transactions. It forms authentication device of the session and generates multiple Passwords/Encryption keys from a single Password/Encryption keys furnished by USER. It authenticates and exchanges objects on behalf of USER, checks for origination of USER's message from within USER's system. Receives objects from SERVICE PROVIDER and passes on the objects received to USER after checks. This agent/software is assigned a temporary, session USER name as IP address of the computer, where from, USER accesses SERVICE PROVIDER. IP address of USER and USER's agent is the same.

Internet Contract Transactions/Network Transactions (ICT): ICT is any Internet transaction, which has some monetary or other value. As SERVICE PROVIDERs allot, USER accounts, USER names and VCSs, only after the USER accepts the conditions of contract, between USER and SERVICE PROVIDER, ICTs include any or all Internet transactions between USER and SERVICE PROVIDER, with a USER account. Temporary USERs who do not have direct account with a SERVICE PROVIDER still transact, using the account with ISP/Network Server after getting the request forwarded by ISP/Network Server. Transactions on credit card, debit card, bank transactions, share market transactions, buying, selling, payment, receipt, gift, bet, sending/receiving emails, accessing information in websites, downloading software or articles, sending or receiving data packets or files, are a few examples of ICTs. There are three methods of authentication and securing of ICTs as detailed below:

Securing of each individual transaction of Known USERs: In BIGENK System, when required, authentication/securing is done for each of the transaction (i) by obtaining Password/Encryption key from USER at the rate of one for each transaction. (ii) by generating multiple Passwords/Encryption keys from one Password/Encryption key initially furnished by a USER. First method is used in automatic transactions between systems (USER and SERVICE PROVIDER are objects), or the security of transactions require individual Passwords/encryption keys, directly from authentication device. Second method is used for all ICTs of established USERs other than specific cases covered in the first method.

Securing of every individual transaction of previously unknown USERs: A previously unknown USER is a USER who is yet to establish an USER account with the SERVICE PROVIDER with whom USER wants to transact and includes temporary/short duration USERs excused from having an USER account. Examples: USERs before setting up an account, one time USERs like, participants in auctions. The system provides for a method to confirm the identity of a previously unknown USER from an ISP with whom that previously unknown USER has an USER account. A temporary authentication device and a Call are passed through the ISP, in an access-restricted folder after ISP authenticates the USER to SERVICE PROVIDER. Previously unknown USER is provided with the Password directly from SERVICE PROVIDER to open the access-restricted folder. The previously unknown USER opens the access restricted folder and furnishes Password to the Call sent to him, from when on the previously unknown USER becomes an authenticated temporary USER to that SERVICE PROVIDER. Then each one of the transactions of previously unknown USER are authenticated and secured by generating multiple Passwords/Encryption keys from one initially Password furnished from the temporary authentication device.

Securing Transactions and Objects exchanged in transactions: In BIGENK System, Call is a permutation of random numbers and variable for every transaction. The string formed by Call of random numbers, is used as additional variable Password or encryption key. This is beneficially used to secure transactions in the following manner: In BIGENK System the objects are exchanged in folders/packets containing unexposed Calls, Passwords, encryption keys and file or messages. The initial Call is sent in unencrypted form. Sending initial Call by user in unencrypted form facilitates USER with low security USER system to request relatively higher security SERVICE PROVIDER system to initiate secure session, with the key specified by the USER. The Password for the initial Call is used as the first encryption key. Using this, the first object exchanged is encrypted and sent. When mutual authentication is performed, the Call and Response of mutual authentication are available as additional encryption keys, before transactions start. When mutual authentication is not performed, the initial Password is used as encryption key for the first object exchanged in the first transaction. All subsequent Calls are sent in encrypted form and unexposed. Therefore, all Passwords, and all Calls other than initial Call are unexposed and useable as encryption keys, to secure every one of the transactions and objects exchanged in transactions. Two encryption keys are available for each transaction. Using the Call for a transaction for object exchange from USER to SERVICE PROVIDER and the Password for a transaction for object exchange from SERVICE PROVIDER to USER is a preferred option. However, Passwords and unexposed Calls are usable to secure any subsequent transaction. The choice of specific Call or specific Password from among the Calls or Passwords generated up to that transaction in a session for encrypting and access restricting a specific folder is by availability or by prior agreement between USER and SERVICE PROVIDER. Padding of keys is used when necessary. Any one of the prior art cryptographic methods of are used for encryption/decryption using encryption keys produced by the system. The cryptographic method is pre agreed. A combination of encryption as well as access restriction is used, so that even when some one is in possession of decryption key, still the object is inaccessible. Since encryption keys and Password are at times, different, Password is tested separately with in the encrypted folder.

Access restriction and ensuring continuity of link: In Internet transactions, access restriction is done by ensuring IP address from which the USER/USER Agent Software or SERVICE PROVIDER are transacting, remains one and the same from beginning to end of session and by obtaining a variable Password/Encryption key known only to USER/USER Agent Software and SERVICE PROVIDER for each object exchanged from that IP address. The method of access restriction to specific IP address supports likelihood of masking of IP addresses, continuously changing of IP addresses, using proxy servers, or similar techniques. Access restriction to specific folder is also done when required.

Distinct features of BIGENK System: Integrates functions of authentication and securing of transactions. The system is usable for securing transactions of a USER for a session or for each transaction or for each object exchanged between SERVICE PROVIDER and USER. The system is self-reliant to provide two different computationally non-intensive, symmetric encryption keys linked with USER's identity to secure each one of the Internet/network transactions of USERs and a plurality of keys for a session. The string formed by Call of random numbers is designed to serve as variable Password/encryption key. Therefore, two different means for two-way authentication/securing are possible using BIGENK System. The system secures each one of the Internet/network transactions of previously unknown USERs in a similar manner to that of a known USER. The system is designed to generate many different Passwords/Encryption keys, from a single Password initially furnished by a USER. This relieves USER from furnishing many Passwords/Encryption keys, which are required to authenticate and secure every transaction and objects exchanged in every Internet/Network transaction.

The system provides a direct and computationally non-intensive means of tracing objects to the originator providing definite proof for solving and Internet transaction related claims. Calling two Encryption keys or equivalent stronger Encryption key in only one chance prevents unauthorised parties making repeated attempts on encryption keys, provides resistance to breaking and automatically notifies genuine USER on failed attempts. Preventing breach attempts is not available in prior art systems. Even if some one manages to break the encryption key, it will be too late as the real transactions would have been completed long before and the discovered key is not going to be used further. It designed to test physical availability of authentication device with USER after a failed attempt. Resistance to breaking and alerting arrangement is in built in the system.

In the system, memorisation is not required. The system has done away with the limit on total number of CUs in the authentication device imposable by memorisation. The system has done away with the limit on Call of random numbers imposable by memorisation. VCS system of authentication devices is used by the system. The Passwords/Encryption keys are unique for each Call and there are no multiple possibilities. Therefore, validation of encryption keys of BIGENK System is only a comparison and is a computationally non-intensive. Multitudes of Passwords/Encryption keys are generated simultaneously or in quick succession. The key management is simple, the keys are computationally non-intensive and keys are variable for every object exchanged. Avoiding memorisation difficult procedures in the system help in automatic generation of many encryption keys without difficulty and facilitate transactions without human intervention. The system provides temporary authentication device for a previously unknown USER generating variable passwords/Encryption keys to authenticate/secure transactions of previously unknown USER. The system generates Passwords/Encryption keys of any required level of safety. User includes persons and objects.

As font/distinguishing property is used, the character variability is larger and number of characters required to produce keys equivalent to keys of DES/AES is given below, for VCS 1 and VCS 5.

| | Number of | Number of | Number of | | |
|---|---|---|---|---|---|
| | BCs used for | BCs used | possible keys | | Comparable to DES/AES |
| VCS | forming | for forming | using all | Equivalent | with possible key |
| No | VCS | key | BCs | bit size | combinations |
| 1 | 64 | 10 | 1.15E+18 | 60 | 56 bit DES with 7.2 × 10¹⁶ |
| | 64 | 22 | 5.44E+39 | 132 | 128 bit AES with 3.4 × 10³⁸ |
| | 64 | 32 | 6.28E+57 | 192 | 192 bit AES with 6.2 × 10⁵⁷ |
| | 64 | 43 | 4.63E+77 | 258 | 256 bit AES with 1.1 × 10⁷⁷ |
| 5 | 512000 | 3 | 1.34E+17 | 57 | 56 bit DES with 7.2 × 10¹⁶ |
| | 512000 | 7 | 9.22E+39 | 133 | 128 bit AES with 3.4 × 10³⁸ |
| | 512000 | 11 | 6.34E+62 | 209 | 192 bit AES with 6.2 × 10⁵⁷ |
| | 512000 | 14 | 8.51E+79 | 266 | 256 bit AES with 1.1 × 10⁷⁷ |

From the above examples it is clear that the keys of BIGENK System with font/distinguishing property variation are shorter than other systems.

Advantageous Effects of the Invention, with Reference to Background Art:

In BIGENK System, securing system is integrated with authentication. Availability of computationally non-intensive, symmetric encryption keys at the rate of one for each object, two for each transaction and many for a session with many advantageous features of BIGENK system is unavailable in prior art.

ICTs authentication and securing of each one of the transactions with multiple Passwords/encryption 935 keys generated out of single Password/Encryption key USER input, from known and Unknown USERs is a special feature unavailable in prior art. Preventing breach of keys by unauthorized persons both within the session and outside the session is also not available in prior art. The securing keys are shorter than that are used in prior art.

### BRIEF DESCRIPTION OF DRAWINGS

FIG. 1 shows VCS 1 to VCS 4.

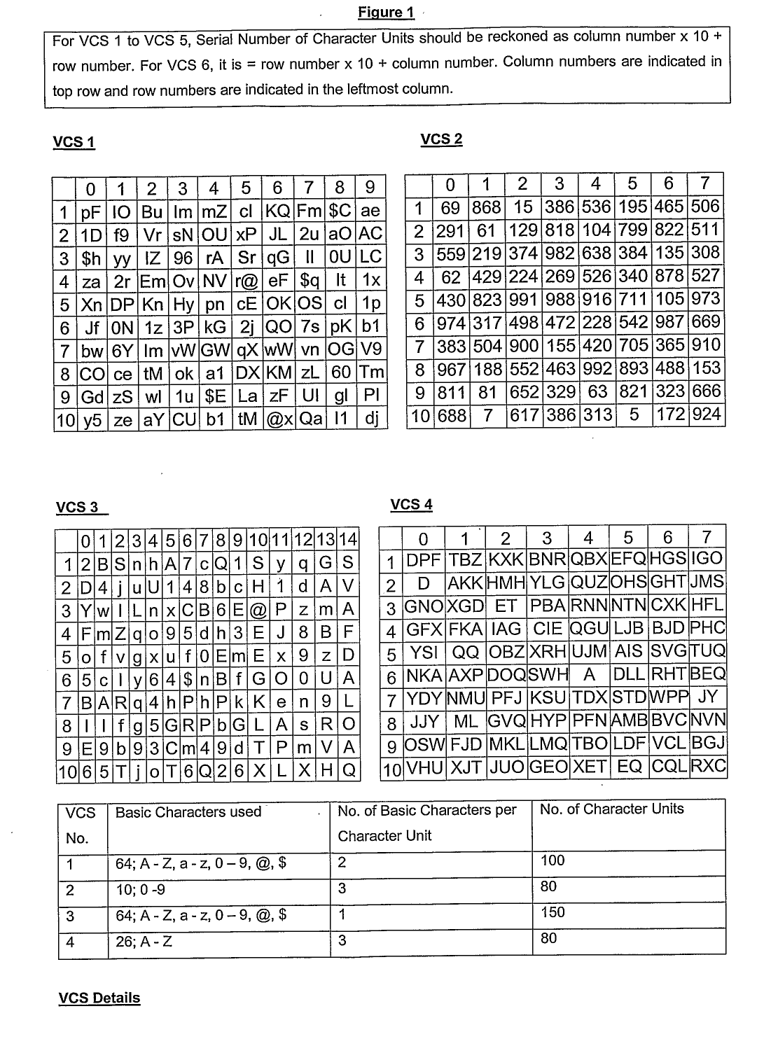

FIG. 2 shows VCS 5.

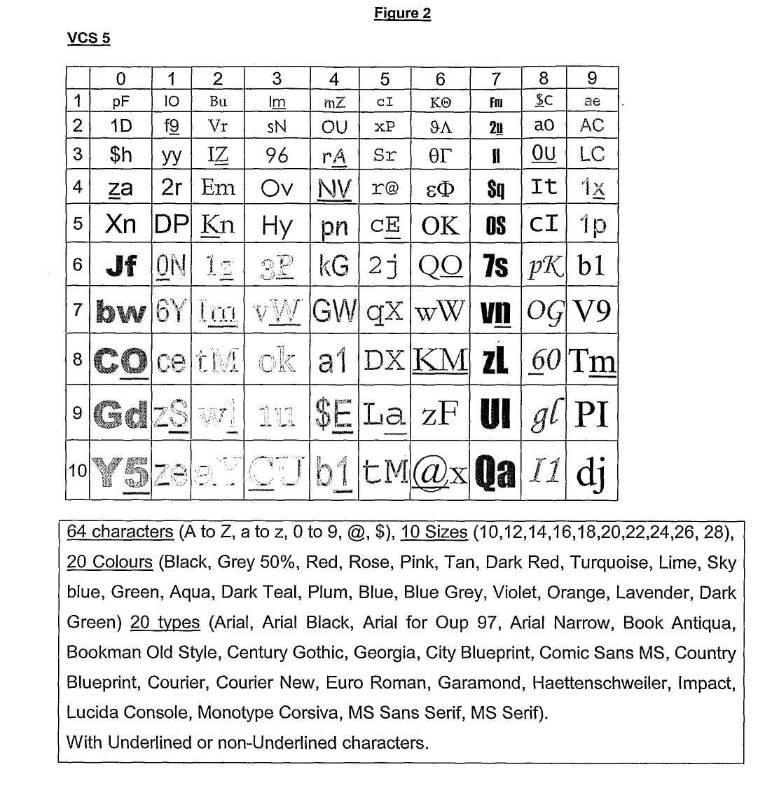

FIG. 3 shows VCS 6.

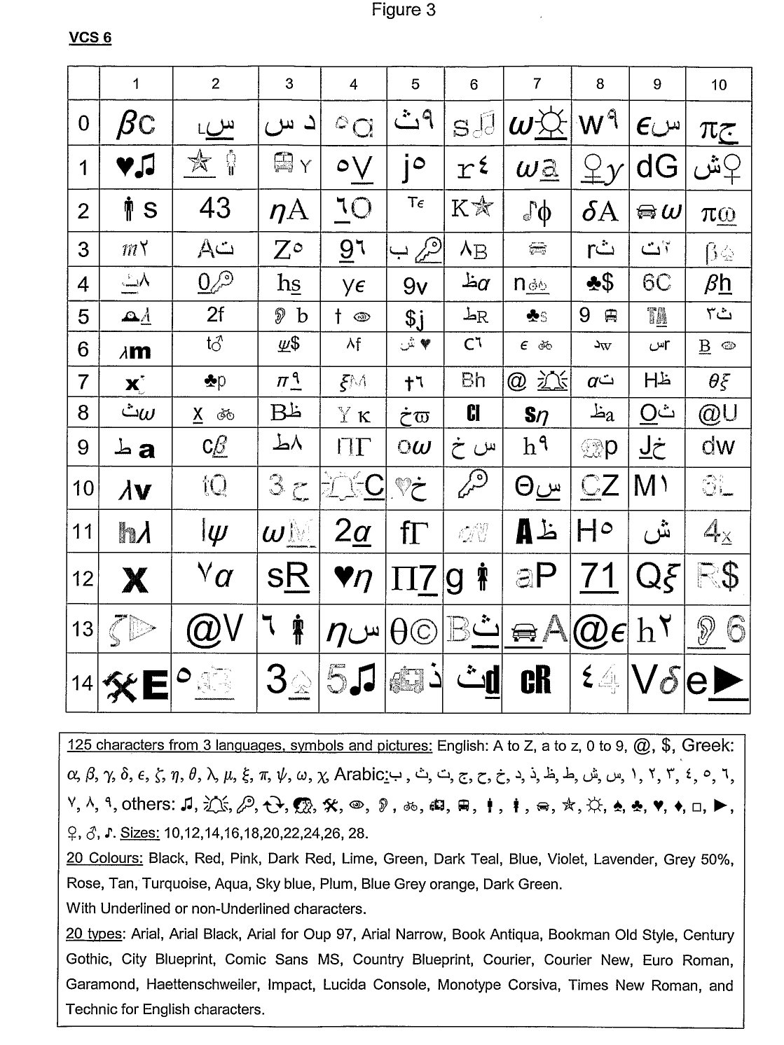

VCS 1 to VCS 6 are Variable Character Sets and provide examples of Basic Characters, Character Units.

FIG. 4, shows MVCS 1, example of Master Variable Character Sets.

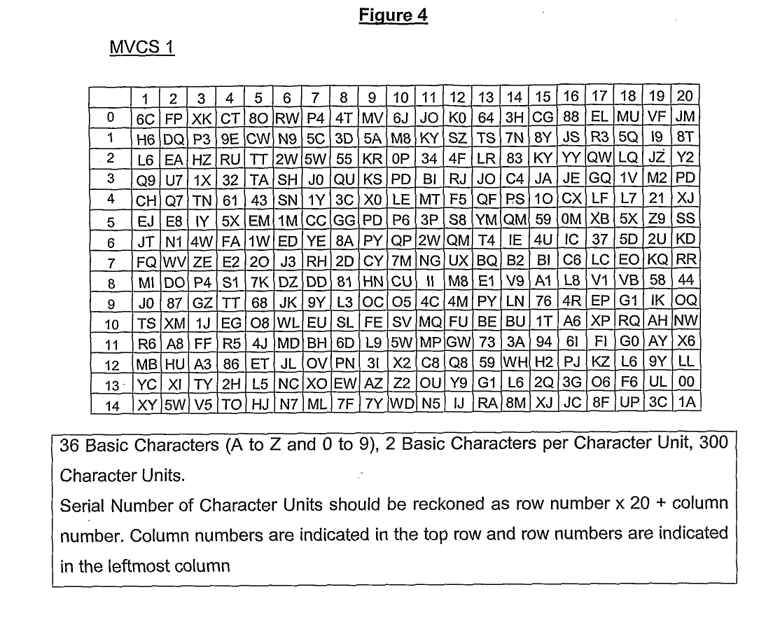

FIG. 5 is a flow chart of method of authenticating and securing of every Internet Contract/Network Transaction of a USER, in which USER has to furnish Password/encryption key for every transaction.

FIG. 6 is a flow chart of method of authenticating and securing of every Internet Contract/Network Transaction of a USER, in which USER need to furnish only one Password/encryption key at the beginning of a session.

FIG. 7 is flow chart of method of authenticating and securing of every Internet Contract/Network Transaction of a previously unknown USER, who/which need to furnish one Password from a temporary authentication device at the beginning of the session.

### MODES OF CARRYING OUT THE INVENTION

Internet Contract Transactions/Network Transactions (ICT): In the methods, a few common procedures are used. Of these, securing transactions and object exchanged in transactions, access restriction and ensuring continuity of link, generating multiple Passwords/encryption keys from one Password and Padding of keys have already been explained. The other common procedures are explained here to avoid repetition.

Chance to correct: All Calls, Passwords/encryption keys are verified for correctness and preagreed number of chances are allowed to rectify. Only on failure to rectify within the given chances, SERVICE PROVIDER/USER/USER agent software exit. Lapse of specified time or inability to open or decrypt folders indicate inability to correct and the parties exit. Exiting transactions are done duly advising the other party, when feasible.

Checking objects exchanged: It is an optional step to check objects exchanged before accepting or saving the files in their respective systems. The checks are for compliance of regulations, contract conditions, and freedom from undesirable programs like virus.

The methods are explained and will be readily understood by the following detailed description in conjunction with the accompanying drawings, wherein like reference numerals designate like structural elements. Only the main steps and important details are shown in drawings. More details are added in the disclosure. Ancillary steps, modifications to the steps and further detailing may be done suiting the SERVICE PROVIDER/USER/type of transaction. The examples furnished here are with unpadded encryption keys which user is expected to furnish.

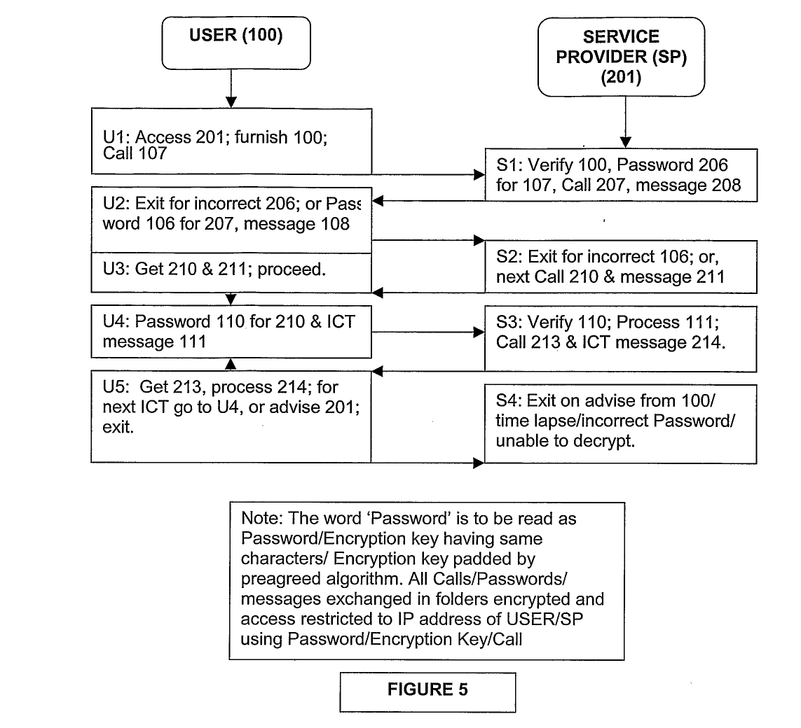

Method of authenticating and securing of every individual Internet Contract/Network transactions of USER with one Password/encryption keV furnished by a USER for each transaction: FIG. 5 is the flow chart of this method. In this, a USER (100) having an USER account with SERVICE PROVIDER (SP), having website (201) doing transactions is illustrated.

In step (U1), USER (100) accesses SP's website (201) by opening the website window; records IP address of SP (202), furnishes USER Name, 100 to SP, refers to authentication device (103) and issues a Call (107) within 103, to SP. This Call is termed as initial Call of the session. This Call is made in open network, is considered as exposed, and is unusable as encryption key.

In step (S1), SP checks 100, if 100 is unregistered, SP refers back. If 100 is registered, SP records IP address of USER (102); locates authentication device (203) pertaining to 100; checks whether the Call is within 203, if the Call is beyond 203, refers back; otherwise, SP creates a folder (205) containing Password/encryption key (206) for 107, Call (207) termed as ‘SERVICE PROVIDER's first Call’ and any message to USER (208), the SP wants to communicate; encrypts 205 using 206, access restricts 205 to 102 using 206 as Password and sends to USER.

In step (U2), USER opens and decrypts 205 using preagreed cryptographic method and 206, which is obtained from 103; checks 206; exits if 206 is incorrect; otherwise creates a folder (105) containing Password/encryption key (106) for 207 and any message to SP (108); encrypts 105 using 207, access restricts 105 to 202 using 207 as Password and sends to SP.

In step (S2), SP opens and decrypts 105, verifies 106; exits if USER authentication fails within allowed chances; if passes, creates a folder (209), containing next Call (210), authentication message to USER (211) encrypts 209 using 106, access restricts 209 to 102 using 106 as Password and sends to USER.

In step (U3), USER opens and decrypts 209; gets 210 & 211; proceeds with next step.

In step (U4), USER creates a folder (109) containing Password/encryption key (110) for 210 & ICT message (111) encrypts 109 using 210 & access restricts 109 to 202 using 210 as Password and sends 109 to SP

In step (S3) SP opens and decrypts 109, verifies 110; checks 111 contents for acceptability; creates a folder (212) containing, next Call (213) & SP's ICT message (214) encrypts 212 using 110; access restricts 212 to 102 using 110 as Password and sends 212 to USER

In step, (U5) USER opens and decrypts 212, checks 214 contents for acceptability. If required to continue, proceeds to step U4, else advise SP and exits.

In step (S4) SP exits on advise from USER/lapse of specified time/incorrect Passwords or encryption keys/unable to decrypt.

The steps U4, S3, U5 are repeated for every transaction, with subsequent folders, Passwords/encryption keys, Calls and ICT messages.

The method uses one Password/encryption key per transaction furnished by a USER. The method is independent of external securing system to secure transactions. Object exchanges are secured by system generated Call/encryption key. Two way authentication and access restriction of objects/messages exchanged ensures continuity of link between SERVICE PROVIDER and USER from beginning till end of session. USER and SERVICE PROVIDER use software programs designed to implement the method.

Example of a stock market transaction requiring individual authentication and securing of each transaction is given below:

USER1 is a client and SP1 is a stockbroker. VCS 4 is the preagreed VCS. The initial dialogue prior to commencement of transactions is

SP1: Please furnish USER name

### USER1: USER1

SP1, verifies USER1, if available, records IP address of USER1
USER1: 24, 53 (Call in open network)
SP1, checks whether the Call is correct. If correct, creates a folder containing Password/Encryption
Key: IAGNTN, Call: 43, 36 & message to USER1. Encrypts and access retricts the folder using an encryption key derived by padding “IAGNTN” and sends to USER1.

USER1 receives the folder from SP1, opens and decrypts the folder using “IAGNTN”, verifies Password/encryption key is “IAGNTN” and gets the Call of SP1.

USER1 creates a folder containing Password/encryption key to SP1's Call: RNNSWH, message, encrypts and access restricts the folder using an encryption key derived by padding “4336” and sends to SP1

SP1 opens and decrypts the folder from USER1, using “4336” checks the Password/encryption key furnished by USER1, finding it correct, issues a welcome message, next Call 2, 67, encrypts and access restricts the folder using “RNNSWH” and sends to USER1.

When USER1 has created first order say sale1, creates a folder containing sale1 and Password/encryption key: DWPP, encrypts and access restricts the folder using “267” and sends to SP1.

SP1 receives, opens and decrypts using “267”, verifies the Password/encryption key and sale1 for compliance of rules and then despatches it to stock exchange. SP1 creates a folder containing an acknowledgement message, next Call: 56, 22, encrypts and access restricts the folder using “DWPP” and sends to USER1.

USER1 receives opens and decrypts using “DWPP” verifies the acknowledgement message, notes the next Call, and proceeds with next order/transaction if required. If not required, advises SP1 and exits.

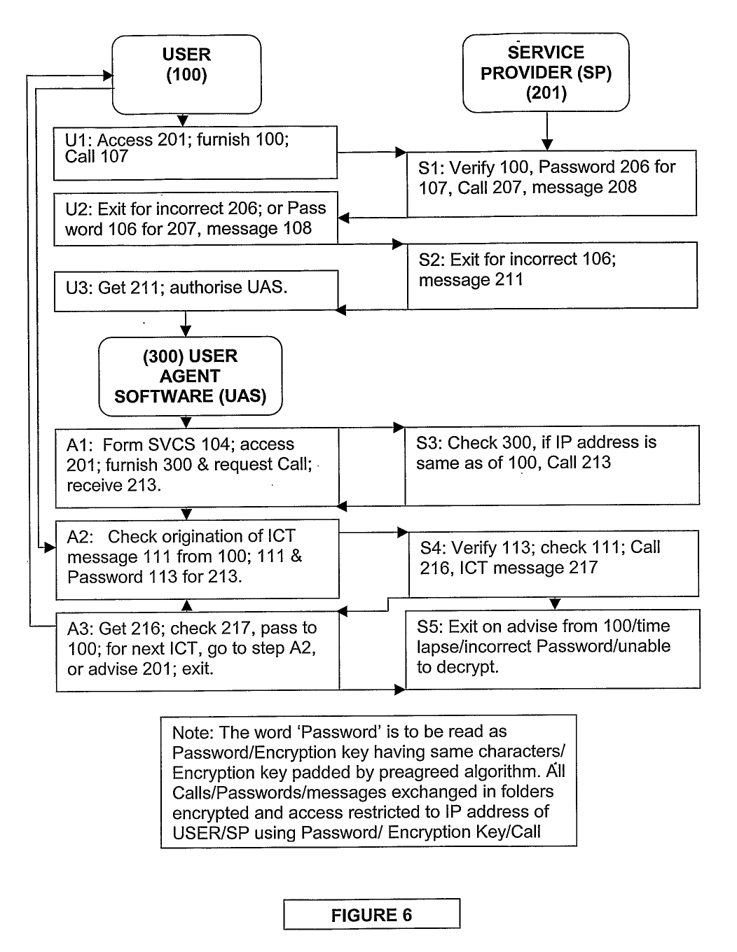

Method of authenticating and securing of every individual Internet Contract/Network transaction generating many Passwords/encryption keys from single Password furnished by USER: FIG. 6 is the flow chart of this method. In this, a USER (100) having an USER account with SERVICE PROVIDER (SP) having website (201), doing transactions, using USER Agent software (UAS) (300) is illustrated.

The steps U1, S1 and U2 are the same as in the method of authentication and securing of every ICT/Network Transactions with one Password/encryption key furnished by a USER for each transaction. The step S2 is also the same except that the Call 210 is not sent to USER. These steps are not repeated here.

In step (U3) USER opens and decrypts 209; if authentication is successful, USER authorizes USER Agent software (UAS) to act further.

In step (A1) UAS collects 207 & 106, forms authentication device of the session (104) with 106 as Character Units & 207 as Serial Number of Character Units; (It is a convenient option; UAS could assign different Serial Number of Character Units and communicate it to SP using 106 to encrypt and access restrict); accesses 201; records 202; furnishes USER Name 300 & requests for Call. After SP responds receives, opens and decrypts 212, gets 213.

In step (S3) SP checks IP address of 300, if it is same as 102, creates a folder (212) containing Call (213) within 104, encrypts 212 using 106, access restricts 212 to 102 using 106 as Password/encryption key and sends to UAS.

In step (A2) UAS receives ICT message (111) from USER; checks for origination of message from within 100 such as continuity of connection of 100 with SP, integrity of command to do the ICT, through checking keyboard and other input entries; creates a folder (112) containing, 111, Password/encryption key (113) for 213, encrypts 112 using 213 & access restricts 112 to 202 using 213 as Password and sends 108 to SP

In step (S4) SP opens and decrypts 112, verifies 113; checks 111 contents for acceptability; creates a folder (215) containing next Call (216), SP's ICT message (217) & encrypts 215 using 113; access restricts 215 to 102 using 113 as Password and sends 215 to UAS.

In step, (A3) UAS opens and decrypts 215, gets 216; checks 217 contents for acceptability and passes it to USER. If required to continue, proceeds to step A2 else advise SP and exits.

The steps A2, S4, A3 are repeated for every transaction, with subsequent folders, Password/encryption keys, Calls and ICT messages.

In step (S5) SP exits on advise from USER/lapse of time/incorrect Password/encryption keys/unable to decrypt.

The interaction between USER agent software and SERVICE PROVIDER takes place without efforts from USER. Only when authentication fails, it is brought to the notice of USER for USER to decide corrective action. Since SVCS/SVCS L2 is formed out of the USER's VCS/SVCS, it is also possible to do authentication/securing directly by USER, if USER has noted down the initial Call of random numbers or Password. When necessary, USER, at any time, interrupts the USER Agent Software. ICTs created by other than authorised USER could not have access to SVCS/SVCS L2 applicable for that session. Any other person/object could not do ICT from any other computer in the name of USER1, because of access restriction to IP address, which differs. Even if it is attempted to originate ICT through the USER's computer, by remote commands, the keyboard entries and USER's commands differ and USER agent software rejects it. Thus, only authenticated ICT is sent to SERVICE PROVIDER and vice versa and every ICT is authenticated with a Password/encryption key of the USER. It also ensures that the file or data packet containing ICTs exchanged between USER and SERVICE PROVIDER are access restricted between SERVICE PROVIDER and USER using Password/encryption key or Call. USER is authenticated once and his actions are authenticated using the same Password/encryption key with no further inputs from USER, who has option to do authentication directly or at any time interrupt USER Agent software. An exact link between USER and actions of USER is established, pinpointing, which USER did which ICT from which computer at what time using which Password/encryption key, which is of definite use to solve ICT related claims. All actions of a USER are traceable from the moment a USER enters Internet through an Internet Service Provider, if all his transactions are treated as ICTs and effected in the manner laid down here. This is of immense use, in a time, when computers are illegally taken over and abused without knowledge of owners.

The method is characterised by using a USER Agent Software, to generate many variable Password/encryption keys from one initial Password/encryption key furnished by USER, at the beginning of the session; authenticating and securing transactions using Call and Password as two different computationally non intensive encryption keys linked to USER's identity to each one of the Internet/network transactions between USER and SERVICE PROVIDER; two way authentication and access restriction of objects/messages exchanged using two different Passwords/encryption keys for each transaction; ensuring continuity of link between SERVICE PROVIDER and USER from beginning till end of session; providing proof for every Internet Contract/Network Transaction of USERs; providing means of tracing all actions of USERs from access to exit, to solve Internet Contract/Network Transaction related claims. The method is independent of external securing system to secure transactions. USER and SERVICE PROVIDER use software programs designed to implement the method.

Example: Example of individual email authentication using the method of authenticating and securing of every individual Internet Contract/Network transaction generating many Password/encryption keys from single Password/encryption key furnished by USER is given below:

USER1 is the USER, SP1 is the email server, and UAS is the email software, which functions as USER1's agent. VCS1 is the pre agreed VCS. USER1 has opened the website of SP1, indicating his desire to do email transaction and approached SP1.

SP1: Please enter your USER name

### USER1: USER1

SP1, verifies USER1, if available, records IP address of USER1
USER1: 73, 41, 100, 9 (Call in open network)

SP1, checks whether the Call is correct. If correct, creates a folder containing Password/encryption key: llmzdjGd, Call: 56, 2, 33, 87 and message to USER1. Encrypts and access retricts using “llmzdjGd” and sends to USER1.

USER1 receives the folder from SP1, opens the folder by furnishing Password/encryption key “llmzdjGd”, decrypts using “IlmzdjGd” and gets the Call of SP1.

USER1 creates a folder containing Password/encryption key to SP1's Call: 2j1D96OG and message, encrypts and access retricts the folder using “5623387” and sends to SP1

SP1 opens and decrypts the folder from USER1, using “5623387” checks Password/encryption key furnished by USER1, finding it correct, welcomes USER1 (Welcome implies that USER is authenticated).

USER1 authorises UAS, passing on the Call: 56, 2, 33, 87 and Password/encryption key 2j1D96OG UAS forms SVCS as below. Accesses SP1, furnishes USER Name, and seeks a Call.

| | | | | |
|---|---|---|---|---|
| SNCU | 56 | 2 | 33 | 87 |
| CU | 2j | 1D | 96 | OG |

SP1 checks IP address of UAS and if it is same as that of USER1, creates a folder containing a Call 56, 87, 33, encrypts and access restricts using 2j1D96OG and sends to UAS.

UAS, receives opens and decrypts using “2j1D96OG”, gets the Call and awaits ICT from USER1. When USER1 has created first email say email1, it is passed on to UAS. UAS checks whether USER1, is logged in to the account, the commands match the email1, creates a folder containing email1, and Password/encryption key: 2jOG96, encrypts and access restricts the folder using “568733” and sends to SP1.

SP1 receives, opens and decrypts using “568733”, verifies Password/encryption key and email1 for compliance of rules and then despatches it to the email address concerned. SP1 creates a folder containing an acknowledgement message and next Call: 56, 87 encrypts and access restricts the folder using “2jOG96” and sends to UAS.

UAS, receives, opens and decrypts using “2jOG96”, and verifies the message contents for acceptability and passes on to USER. Retains the Call. Subsequent emails could have Calls and Password/encryption keys as below:

### Email2, Call: 56, 87 Password/encryption key: 2jOG

Email3, Call: 87, 56, 2, 33 Password/encryption key: OG2j1D96
Email4, Call: 56, 33, 2 Password/encryption key: 2j961D, etc.

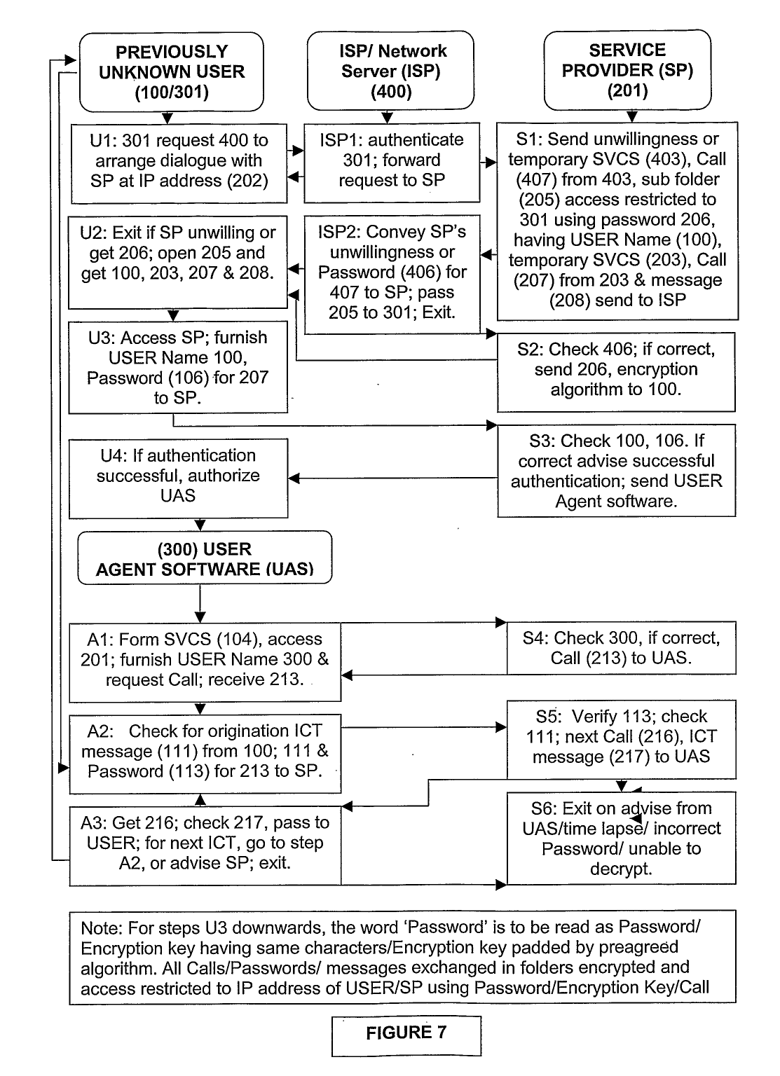

Method of authentication and securing of every individual Internet/Network transaction of a Previously unknown USER generating different Password/encryption keys from one Password/encryption keV: FIG. 7 is the flow chart of this method. In this, a previously unknown USER (100/301) having an USER account with Internet SERVICE PROVIDER/Network Server (ISP), establishing authenticity to SERVICE PROVIDER having website (201) through the ISP and doing transactions, using USER Agent software is illustrated.

In step (U1), USER with IP address 102 and USER Name with ISP as 301, requests ISP (400) to arrange dialogue with SP, furnishing IP address of SP (202)

In step (ISP1), the ISP authenticates 301 with a Password (306) between USER & ISP; forwards USER's request to SP (201) with USER details

In step (S1), SP considers the request. If unwilling to transact with 301, sends unwillingness to ISP. If willing to transact, creates a folder (405) containing temporary SVCS (403) meant for ISP, a Call (407) from 403, a sub folder (205) containing USER Name (100), temporary SVCS meant for the previously unknown USER (203), a Call (207) from 203 & message (208), encrypts 205 with a Password to be sent later (206) & access restricts 205 to 102 using 206 as Password and sends 405 to ISP

In step (ISP2), the ISP conveys SP's unwillingness to USER if so received. If folder is received, opens folder 405, furnishes Password (406) for 407 to SP & passes on 205 to USER; ISP exits, after sending the folder to 301.

In step (S2), SP checks 406 received from ISP; if it is correct, then it sends 206 direct to previously unknown USER along with encryption algorithm.

In step (U2) previously unknown USER exits if SP unwilling to transact or gets 206 & encryption algorithm; opens 205 and gets 100, 203, 207 & 208.

In step (U3) previously unknown USER accesses SP's website (201); records IP address of SP (202), furnishes USER Name 100, creates a folder (105) containing, Password/Encryption Key (106) for 207 to SP; encrypts 105 using 207, access restricts 105 to 202 using 207 as Password and sends to SP.

In step (S3) SP checks 100, records IP address of previously unknown USER (102); locates authentication device (203) opens and decrypts 105, verifies 106; If found correct, advises previously unknown USER's successful authentication; from this stage previously unknown USER, becomes an authenticated but temporary USER to SP; SP sends USER Agent software on request. SP exits if USER authentication fails, within 3 chances.

In step (U4) 100, authorizes UAS to act further, if authentication successful.

The steps that follow (A1), (S4), (A2), (S5), (A3) and (S6) are similar to steps (A1), (S3), (A2), (S4), (A3) and (S5) of the method of authenticating and securing of every individual Internet Contract/Network transaction generating many Password/encryption keys from single Password/encryption key furnished by the USER. Other than the steps of initial authentication of previously unknown USER, this method has similar characteristic features of the previous method and hence not repeated here.

Example of a transaction of previously unknown USER participating in an auction is given below: PUUSER wants to participate in the auction conducted by SP1. PUUSER is not registered with SP1. PUUSER has account with ISP1.

PUUSER requests ISP1 to arrange a dialogue with SP1. ISP1 authenticates PUUSER with a Password.

Passes on the request to SP1.

SP1 has MVCS1 as the authentication device. SP1 sends an SVCSr with SNCUs from 1 to 8 and Call: 7, 4, 1 meant for ISP1 and SVCSn having SNCUs from 161 to 169 for PUUSER and Call 167, 169, 164, 166 meant for PUUSER, access restricts folder containing SVCSn, Call and Message to PUUSER's IP address, with a Password “PN3CRA” and sends to ISP1.

| SVCSr | | | | | | | | SVCSn | | | | | | | | |
|---|---|---|---|---|---|---|---|---|---|---|---|---|---|---|---|---|
| 1 | 2 | 3 | 4 | 5 | 6 | 7 | 8 | 161 | 162 | 163 | 164 | 165 | 166 | 167 | 168 | 169 |
| 6C | FP | XK | CT | 8O | RW | P4 | 4T | MI | DO | P4 | S1 | 7K | DZ | DD | 81 | HN |

ISP1 furnishes Password: P4CT6C to SP1 and passes on the folder containing SVCSn to PUUSER. SP1 after verifying Password from ISP1, sends PUUSER, the Password “PN3CRA” to open the folder. PUUSER's opens the folder, using “PN3CRA”, gets SVCSn, Call. Furnishes Password/encryption key: DDHNS1DZ. SP1 verifies and accepts to transact with PUUSER.

PUUSER gets UAS, authorises UAS.

UAS forms SVCSL2 as shown and seeks a Call.

| | | | |
|---|---|---|---|
| 167 | 169 | 164 | 166 |
| DD | HN | S1 | DZ |

SP1 issues Call: 166, 164, 167, encrypts using “DDHNS1DZ”.

UAS opens and decrypts the folder from SP1 using “DDHNS1DZ” and gets the Call.

PUUSER participates in auction, witnesses bids in progress, makes the first bid say bid1, and passes it to UAS. UAS verifies the origination of message and creates folder with bid1, Password/encryption key: DZS181, encrypted and access restricted using “166164167” sends it to SP1.

SP1 receives, opens and decrypts, checks Password/encryption key and if correct accepts bid1. Sends acknowledgement, next Call in folder encrypted and access restricted with “DZS181” and sends to UAS.

UAS receives, opens and decrypts, checks and if everything is correct sends it to PUUSER, retains the Call. Awaits further bids from PUUSER.

The succeeding bids could have the following Calls and Password/encryption keys

### Bid2, Call: 164, 169 Password/encryption key: S1HN

### Bid3, Call: 166, 169, 167 Password/encryption key: DZHNDD, etc.

### INDUSTRIAL APPLICABILITY

BIGENK System with BIGENKs and NRBIGENKs are useable as Independent Symmetric Encryption Key System, with desired level of security, higher than what is provided by present Encryption key systems, where keys are not required to be exchanged and breaking attempts are prevented, providing 1215 a safer encryption key system. The different methods of authenticating and securing transactions are used depending upon the type of USER/type of use.

1) The Bilaterally Generated Encryption Key System, characterised in that a system, integrating functions of authentication and securing of transactions providing one encryption key for each object exchanged between USER and SERVICE PROVIDER, two different encryption keys per transaction and a plurality of encryption keys for a session; securing each one of the Internet/network transactions of USERs and previously unknown USERs; generating many variable keys of required length, linked with USER's identity at the instant of transaction; providing computationally non intensive symmetric keys, dispensing with exchange of keys/memorisation, designed to generate plurality of encryption keys from single initially furnished Password/Encryption key, relieving USER from further input, having less number of keys for the level of security; preventing breach attempts on the encryption key; providing a direct and computationally non intensive means of tracing objects to the originator, using Variable Character set system of authentication devices comprising key generation process, the system and interface programs executable by SERVICE PROVIDER/USER systems; the system generating two types of encryption keys namely Bilaterally Generated Encryption keys and Non Repeating Bilaterally Generated Encryption keys; the system designed to perform authentication and transaction security based tasks such as (a) authenticating and securing of every individual Internet Contract/Network transactions of USER with one Password/encryption key furnished by a USER for each transaction, combined with securing of objects exchanged between USER and SERVICE PROVIDER using one Password/Encryption key furnished by USER and one system generated, as Passwords/encryption keys for each transaction; (b) authenticating and securing of every individual Internet Contract/Network transaction of a USER with different encryption keys, generating said different encryption keys from a single Password/Encryption key furnished by USER at the beginning of a session using USER Agent Software, combined with securing of objects exchanged between USER and SERVICE PROVIDER by two system generated Passwords/encryption keys for each transaction and providing proof for all transactions of USER; (c) authenticating and securing of every individual Internet/Network transaction of a previously unknown USER with different Password/Encryption keys, generating said different Password/Encryption keys from one Password/Encryption key furnished from a temporary authentication device by a previously unknown USER at the beginning of a session using a specially designed USER Agent Software combined with authentication of objects exchanged between USER and SERVICE PROVIDER by two system generated Passwords/encryption keys for each transaction and providing proof for all transactions of previously unknown USER.

2) The system claimed in any preceding claim, USER is a person or a process or software or specified sector(s) of data storage media or a system or server or a Network or any thing that uses a Password/Encryption key for authentication and securing transactions; a previously unknown USER is a USER having an USER account with a Internet SERVICE PROVIDER or Network server but is yet to establish an USER account with a SERVICE PROVIDER with whom such USER wants to transact and includes first time/temporary USERs/short duration USERs excused from having an USER account such as participants in auctions.

3) The system claimed in any preceding claim, SERVICE PROVIDER is a person or a process or software or specified sector(s) of data storage media or a system or server or a Network or any thing who/which provides access to the USER upon furnishing of valid Password/Encryption key for authentication.

4) The system claimed in any preceding claim, an encryption key is generated using the said system, include Bilaterally Generated Encryption Key and Non Repeating Bilaterally Generated Encryption Key/Encryption keys and is a permutation of Character Units of the authentication device, optionally padded to required length.

5) The system claimed in any preceding claim, ‘access restriction’ is to restrict access of USER to within confines of the specified SERVICE PROVIDER.

6) The system claimed in any preceding claim, a transaction comprise of an action of USER and the subsequent Response of SERVICE PROVIDER; Internet Contract transaction is an Internet transaction between USER and SERVICE PROVIDER which has a monetary or other value; authentication/securing of every individual transactions is to authenticate/secure every transaction using different Password/Encryption keys from USER either individually furnished by USER or generated from single Password/Encryption key initially furnished by USER.

7) The system claimed in any preceding claim, objects exchanged between USER and SERVICE PROVIDER include files or message packets generated in transactions, unexposed Calls, Password/Encryption keys, contained in folders, encrypted, access restricted and exchanged between USER and SERVICE PROVIDER; securing objects exchanged is to secure every object exchanged in transactions using Password/Encryption keys/Calls linked to the identity of USER.

8) The system claimed in any preceding claim, symmetric encryption key system requiring no exchange of keys is that using the system and an authentication device, a multitude of encryption keys are obtainable, exchanging keys are dispensed with, only the inverse keys, which are random numbers, decipherable only by USER/SERVICE PROVIDER in possession of authentication device are exchanged; solving the problem of key changing and key management with multitude of service providers and USERs; wide adaptability to all uses of encryption; to secure transactions and objects exchanged in the transactions; two Passwords/encryption keys for each transaction are (a) the string formed by Call of random numbers for a transaction which are the inverse keys made of a permutation of random numbers when unexposed, are useable as additional encryption keys, wherein all Calls excluding the initial Call are unexposed and (b) Password for a transaction; used as Password/encryption keys for exchanging objects between USER and SERVICE PROVIDER.

9) The system claimed in any preceding claim, maintaining link is to ensure both USER/USER Agent Software and SERVICE PROVIDER and IP address from which USER/USER Agent Software and SERVICE PROVIDER are transacting remains one and the same from beginning to end of a session.

10) The system claimed in any preceding claim, USER Agent Software is a specially designed software representing USER, transacting with SERVICE PROVIDER; integrated with Internet Contract/Network Transaction software or an independent software; functions from the USER's system; assigned USER name, as IP address of the computer, wherefrom, USER accesses SERVICE PROVIDER; forms the authentication device of the session and generates multiple Password/Encryption keys from a single Password/Encryption key furnished by USER; authenticates individual transactions and exchanges objects on behalf of USER, checks for origination of USER's message from USER's system and passes on the objects received from Service Provider to USER after checks.

11) The system claimed in any preceding claim, generating multiple Password/Encryption keys from single Password/Encryption key using an USER Agent Software is to generate many Password/Encryption keys using different permutations of the Character Units of one Password/Encryption key; wherein the pre agreed authentication device having same number of Basic Characters per Character Unit for all Character Units; Call is for a minimum of 4 Character Units, ensuring at least 60 unique permutations are formed from 4 Character Units; USER Agent Soft ware collecting the Call and Password/Encryption key for initial access of USER; determining the total number of Character Units and Character Units from the Call and Password/Encryption key for initial access of USER; forming a Sub Variable Character Set of any Level termed as authentication device of the session using all Character Units; assigning Serial Number of Character Units which optionally are non consecutive numbers of two or more digits and communicating the assigned Serial Number of Character Units to SERVICE PROVIDER in encrypted folder using the Password/Encryption key for initial access of USER; wherein the first unexposed Call is usable by prior agreement as Serial Number of Character Units dispensing with the need of communicating Serial Number of Character Units; SERVICE PROVIDER making all Calls within the authentication device of the session; randomly varying the number of Character Units in each Call between 2 and total number of Character Units in the authentication device of the session, whereby a plurality of Password/Encryption keys are generated, the encryption keys are optionally padded to obtain required length of the keys.

12) The system claimed in any preceding claim, temporary authentication device is an authentication device sent to previously unknown USER through USER's Internet Service Provider/Network Server.

13) The system claimed in any preceding claim preventing breach attempts on the encryption key is (a) when the USER and SERVICE PROVIDER are in session, (a1) USER failing to furnish the correct Encryption key within given chances resulting in aborted transaction; (a2) subsequent attempt taking place only after specified time and (a3) the USER furnishing 2 Encryption keys successively or equivalent stronger Encryption key, entered in first chance itself; (a4) USER failing to furnish Encryption key in a double Encryption key Call or double strength Encryption key Call at first chance, is denied access until USER establishes his authenticity to the satisfaction of the SERVICE PROVIDER through other means (b) when the USER and SERVICE PROVIDER are not in session and a USER attempts to open an encrypted message such as a saved message, (b1) the system is designed to reject after allowing specified number of chances, noting the date and time of rejection and no further attempts are allowed (b2) the system creating a file having failed attempt data in the USER's system, such file is created only if there is a failure, such file's access is restricted to particular encrypted message by a strong password, such password is unrelated to Variable Character Set/encryption key/Call and known only to SERVICE PROVIDER (b3) USER mandated to contact the SERVICE PROVIDER to recover the message (b4) recovery of such message shall be effected by SERVICE PROVIDER sending the password to delete the file having failed attempt data (b5) after deleting the file, USER is allowed to furnish encryption again, referring to Variable Character Set, whereby, unauthorised persons breach attempts are prevented totally.

14) The system claimed in any preceding claim, providing proof for a transaction is to preserve the Call and Password/Encryption key of each transaction along with Internet Protocol address wherefrom USER transacted, date, time and USER details, including Internet Protocol address of Internet Service Provider/Network Server who'forwarded the request of previously unknown USERs, as means of tracing source of objects in a direct and computationally non intensive manner as the proof of that transaction.

15) The use of the Bilaterally Generated Encryption key System including the key generation process, the system and interface programs executable by SERVICE PROVIDER/USER systems as claimed in claims 1 to 14.

16) The Variable Character Set system of authentication devices used as means of generating variable and instant Passwords/Encryption Keys by authorised USERs and as means of verifying the variable and instant Passwords/Encryption Keys by SERVICE PROVIDERs providing access and service to USERs, in Bilaterally Generated Encryption Key System, including (a) Variable Character Sets {VCS1 to VCS 6}, (b) Master Variable Character Sets {MVCS1}, (c) Sub Variable Character Sets and (d) Sub Variable Character Sets of Level 2 or below; wherein the system further comprise of three optional subsystems, namely (e) Variable Character Set for both SERVICE PROVIDER and USER, (f) Master Variable Character Set with a Sub Variable Character Set expressed in brief form for SERVICE PROVIDER and a Sub Variable Character Set for USER and (g) Master Variable Character Set with a Sub Variable Character Set of Level 2 or below expressed in brief form for SERVICE PROVIDER and a Sub Variable Character Set of Level 2 or below for USER; wherein any one of the three subsystems are used as authentication device.

17) The system as claimed in claim 16, the authentication device comprise of (a) an arrangement of a plurality of Character Units in which the Character Units are identified using unique Serial Number of Character Units; (b) the arrangement is designed to obtain different variable Passwords/Encryption Keys formed of all permutations of a selected number of Character Units; (c) the Character Units are preformed, which remain unchanged during Password/Encryption Key generation; (d) the Character Units have any type of character in any part of Character Unit; (e) the Character Unit consist of either one or a permutation of more than one Basic Character, the number of Basic Characters per Character Unit, acceptable to USERs to read and reproduce; (f) the Basic Characters are selected from a plurality of characters including alphanumeric characters chosen from a plurality of languages/scripts/numbers/symbol systems including non familiar languages/scripts/numbers/symbol and graphical characters chosen from a plurality of representation of objects including diagrams, drawings, images, photos, pictures and sketches; (g) the characters are further differentiated, optionally by font/distinguishing properties; (h) in a preferred mode, the said arrangement used by USERs, is in printed form of size similar to a credit card; (i) the authentication devices are self sufficient to locate and read characters of Password/Encryption key; (j) the Password characters are directly obtained from the authentication devices; characterised in that (k) memorisation is dispensed with; (l) the Character Units of the said arrangement comprise of completely random characters; (m) the Basic Characters are further variable after printing in printed authentication devices; (n) the total number of Character Units in the authentication device is unrestricted by human memorisable level removing the corresponding limit on Serial Number of Character Units imposable by memorisation; (o) the Serial Number of Character Units identify corresponding Character Unit; no further relationship exists between Character Units and Serial Number of Character Units and no relation ship exists among the Character Units in the said arrangement; (p) the said arrangement is free from algorithms/pattern forming methods requiring recalling and implementation of the said algorithms/pattern forming methods to produce Password/Encryption Keys; (q) the said arrangement is designed to produce a plurality of Passwords/Encryption Keys simultaneously or in quick succession; (r) the said arrangement is designed to produce a plurality of Passwords/Encryption Keys from a single Password/Encryption Keys; (s) the authentication devices are designed to produce Passwords/Encryption Keys of chosen level of safety.

18) The system as claimed in claim 16, storing of one Master Variable Character Set and one Sub Variable Character Set of any level in brief form, characterised in that, (a) reduces data storage requirement of SERVICE PROVIDER; (b) provides ease of identifying Character Units in programs in terms of Serial Number of Character Units of Master Variable Character Set; (c) provides unique representation of Character Units of all Sub Variable Character Sets of any level; (d) facilitates automatic classification of USERs on access; (e) facilitates generation of several Passwords/Encryption Keys from single Password/Encryption Key initially furnished by a USER, for authentication of individual Internet transactions including objects exchanged, linking with identity of USER.

19) The system as claimed in claim 16, selecting and using Basic Characters comprise of (a) selecting the total number of Basic Characters to ensure the number of permutations of Basic Characters forming unique Character Units and number of permutations of Character Units forming unique Variable Character Sets are sufficient to cover the safety requirements of Passwords/Encryption Keys and the requirement of unique Variable Character Sets for all USERs of a SERVICE PROVIDER; (b) selecting single characters from any type such as Alphabets, Numbers and Symbols of any language or script, any representation of objects identifiable as distinct units such as diagrams, drawings, images, photos, pictures, sketches; (c) selecting optionally, the font/distinguishing properties facilitating interpretation of one character in many ways including any or all properties distinctly identifiable by USER and SERVICE PROVIDER, such as font type, size, colour, Underlined, Bold, Italics, patterns, shading; (d) the choice of characters in such selection includes non familiar languages, number and symbol systems; (e) the choice of characters and font/distinguishing properties selection includes characters/font/distinguishing properties made available through scroll/drop down menus in which such scroll/drop down menus are unrestricted by algorithms as to the order/method of selection and offer freedom to select any character/font/distinguishing properties; (f) characters and font/distinguishing properties selected in steps (b) to (e) are to be compatible with USER and SERVICE PROVIDER systems; (g) selection of Basic Characters is completed by arriving at every possible combination of each of the characters and each one of the font/distinguishing properties; (h) printing or writing of Basic Characters with similar appearance such as alphabet ‘l’ and number ‘1’, in unique way to facilitate correct reading of Character Units.

20) The system as claimed in claim 16, generating Character Units comprise of: (a) selecting the number of Basic Characters per Character Unit acceptable to USERs to read and reproduce; (b) the number of permutations of Character Units forming unique Variable Character Sets meeting the requirement of USER and SERVICE PROVIDER; (c) optionally varying the number of Basic Characters per Character Unit within the Character Units of a Variable Character Set up to 10% of total number of Character Units of a Variable Character Set, {VCS 2 and VCS 4}; (d) selecting the number of Character Units in Variable Character Sets to ensure total number of Passwords/Encryption Keys generated from the Variable Character Sets is sufficient to fulfil the requirements of USER and SERVICE PROVIDER; (e) generating the Character Units by random choice of single Basic Character-Character Units or random permutation of multiple Basic Character-Character Units using all the Basic Characters selected, wherein such random permutation includes repeating a Basic Character within same Character Unit.

21) The system as claimed in claim 16, generating and using a Variable Character Set, comprise of (a) selecting the required number of Character Units, considering the requirements of USERs, the type of Passwords/Encryption Keys (Repeating or Non Repeating), the number of Character Units per Password/Encryption Key and Password/Encryption Key Safety level desired; (b) arranging the Character Units in any one form of lists, tables, arrays and matrices, in which each of the Character Unit is distinctly identifiable and easily readable; (c) assigning unique Serial Number of Character Unit to identify each Character Unit in Variable Character Set; (d) specifying the method of identifying/calculating the Serial Number of Character Unit, facilitating USER to read the Character Units corresponding to the Serial Number of Character Units; (e) ensuring that the Character Units and the Serial Number of Character Units are unrelated and the Character Units of a Variable Character Set are unrelated to each other; (f) printing the said arrangement in a paper or a card of any size, a preferred size is that of a credit card, capable of generating a million or more unique Passwords/Encryption Keys or storing the said arrangement in encrypted file form; (g) USER optionally making and SERVICE PROVIDER validating the arrangement for compliance of the methods stated here in (h) SERVICE PROVIDER and USER storing the arrangement securely; (i) in special cases to identify previously unknown USERs, publishing or passing through another authenticating SERVICE PROVIDER.

22) The system as claimed in claim 16, generating and using Master Variable Character Set {MVCS1}, suiting a SERVICE PROVIDER having large number of USERs, containing all the Sub Variable Character Sets of USERs and furthermore Sub Variable Character Sets derivable, comprise of (a) Selecting the required number of Character Units, considering the requirements of all USERs, USER groups, the type of Passwords/Encryption Keys (Repeating or Non Repeating), the number of Character Units per Password/Encryption Key and Password/Encryption Key Safety level desired; (b) arranging the Character Units in any one of the form of lists, tables, arrays and matrices, in which each of the Character Unit is distinctly identifiable and easily readable; (c) assigning unique Serial Number of Character Unit to identify each Character Unit in the Variable Character Set; (d) specifying the method of identifying/calculating the Serial Number of Character Unit, facilitating to read the Character Units corresponding to the Serial Number of Character Units; (e) ensuring that the Character Units and the Serial Number of Character Units are unrelated and the Character Units of a Variable Character Set are unrelated to each other; (f) Upon generation of Sub Variable Character Sets by USERs, generating the Master Variable Character Set by combining USER generated Sub Variable Character Sets of all USERs of a SERVICE PROVIDER, as continuous and non-overlapping lists or tables or arrays or matrices; (g) storing and using the arrangement securely by SERVICE PROVIDER as the principal authentication device for all USERs.

23) The system as claimed in claim 16, generating and using Sub Variable Character Set comprise of (a) selecting the required number of Character Units of the Master Variable Character Set, considering the requirements of USERs, the type of Passwords/Encryption Keys (Repeating or Non Repeating), the number of Character Units per Password/Encryption Key and Password Safety level desired; (b) specifying rules to generate Sub Variable Character Set in terms of Serial Number of Character Units of the Master Variable Character Set, or specifying discrete/continuous/random sequences of Serial Number of Character Units of the Master Variable Character Set; (c) selecting Character Units including a limited number of Character Units of other Sub Variable Character Sets, duly ensuring that no specific relationship exists, between Character Units of Sub Variable Character Sets of same origin (d) arranging Character Units selected as per steps (a) to (c) of this claim in to any one of the form of lists, tables, arrays and matrices, in which each of the Character Unit is distinctly identifiable and easily readable; (e) assigning unique Serial Number of Character Unit, independent of Serial Number of Character Units of Master Variable Character Set to identify each Character Unit in the Sub Variable Character Set; (f) specifying the method of identifying/calculating the Serial Number of Character Unit, facilitating USER to read the Character Units corresponding to the Serial Number of Character Units; (g) ensuring that Character Units and Serial Number of Character Units are unrelated and the Character Units of a Sub Variable Character Set are unrelated to each other; (h) assigning a Serial Number/identification number to each Sub Variable Character Set, wherein prefixing or suffixing identification number of Sub Variable Character Sets with Password/Encryption Key, is used to identify any Password/Encryption Key specific to a particular Sub Variable Character Set, which in turn is used for identification of groups and classification of USERs (i) the method of generating Sub Variable Character Sets by USERs, is same as method of generating Variable Character Sets A) individual Variable Character Sets or Sub Variable Character Sets are functionally same for USERs (k) compromised Sub Variable Character Set is replaced with another Sub Variable Character Set from the same Master Variable Character Set; (I) SERVICE PROVIDER storing Sub Variable Character Sets in brief form as in step (b); (m) USERs storing Sub Variable Character Sets in complete form (n) Password/Encryption Key Calls are in Serial Number of Character Units of Sub Variable Character Sets (o) SERVICE PROVIDER compares with Character Units of Master Variable Character Set corresponding to the called Serial Number of Character Units of Sub Variable Character Sets.

24) The system as claimed in claim 16, generating and using of Sub Variable Character Sets of level 2 or below, comprise of (a) selecting the required number of Character Units of the one level up Sub Variable Character Set, considering the requirements of USER's, purpose, the type of Passwords/Encryption Keys (Repeating or Non Repeating), the number of Character Units per Password/Encryption Key and Password/Encryption Key Safety level desired; (b) specifying rules to generate Sub Variable Character Set of Level 2 or below in terms of Serial Number of Character Units of the one level up Sub Variable Character Set, or specifying discrete/continuous/random sequences of Serial Number of Character Units of the one level up Sub Variable Character Set; (c) selecting Character Units including a limited number of Character Units of one level up Sub Variable Character Sets/Master Variable Character Set, duly ensuring that no specific relationship exists, between Character Units of Sub Variable Character Sets any level of same origin; (d) arranging Character Units selected as per steps (a) to (c) of this claim in to any one of the form of lists, tables, arrays and matrices, in which each of the Character Unit is distinctly identifiable and easily readable; (e) assigning unique Serial Number of Character Unit, independent of Serial Number of Character Units of one level up Sub Variable Character SeVMaster Variable Character Set to identify each Character Unit in the Sub Variable Character Set of Level 2 or below; (f) specifying the method of identifying/calculating the Serial Number of Character Unit, facilitating USER to read the Character Units corresponding to the Serial Number of Character Units; (g) ensuring that the Character Units and the Serial Number of Character Units are unrelated and the Character Units of a Sub Variable Character Set of Level 2 or below are unrelated to each other; (h) assigning a Serial Number/identification number to each Sub Variable Character Set of Level2 or below, wherein prefixing or suffixing identification number of Sub Variable Character Sets of Level 2 or below with Password/Encryption Key, is used to identify any Password/Encryption Key specific to a particular Sub Variable Character Set of Level 2 or below, which in turn is used for identification of groups and classification of USERs; (i) USER optionally forms Sub Variable Character Set of level 2 or below duly selecting randomly the required number of Character Units out of Character Units of one level up Sub Variable Character Sets provided by SERVICE PROVIDERs; (j) individual Variable Character Sets or Sub Variable Character Sets of Level 2 or below are functionally same for USER; (k) compromised Sub Variable Character Set of level 2 or below is replaced with another Sub Variable Character Set of level 2 or below from the same one level up Sub Variable Character Set; (l) SERVICE PROVIDERs storing Sub Variable Character Sets of level 2 or below in brief form, by specifying rules in terms of Serial Number of Character Units of the Master Variable Character Set, or specifying discrete/continuous/random sequences of Serial Number of Character Units of the Master Variable Character Set; (m) USERs storing Sub Variable Character Sets of Level 2 or below in complete form; (n) Password/Encryption Key Calls are in Serial Number of Character Units of Sub Variable Character Sets of Level 2 or below; (o) the validating system compares with Character Units of Master Variable Character Set corresponding to the called Serial Number of Character Units of Sub Variable Character Sets of Level 2 or below.

25) The use of Variable Character Set System of authentication devices as claimed in claim 16 to 24.

26) The method of repeated variation of font/distinguishing properties such as font type, size, colour, Underlined, Bold, Italics, patterns, shading, as means of differentiation between same characters of Password/Encryption Keys, in printed Variable Character Set system of Authentication Devices, characterized in that (a) repeated variation of font/distinguishing properties on the characters of Variable Character Sets/Master Variable Character Sets/Sub Variable Character Sets of any level in use, to generate, any time, any number of times, new Character Units and new Variable Character Sets/Sub Variable Character Sets of any level, to enhance security against breach/theft of Passwords/Encryption Keys, enhance life of Authentication Devices and ability of use with any number of SERVICE PROVIDERs comprising steps of (b) USER, optionally, proposing changes to font/distinguishing properties of characters of Password/Encryption Key/Character Units of Variable Character Sets/Sub Variable Character Sets of any level; optionally SERVICE PROVIDER proposing variation of font/distinguishing properties at regular intervals and USER agreeing to such variations; (c) SERVICE PROVIDER registering the changes; (d) USER using a separate transparent sheet to the size of printed Variable Character Sets/Sub Variable Character Sets of any level, indicating font/distinguishing property variation (e) willing USER memorising the changes; (f) furnishing font/distinguishing properties varied characters for Password/Encryption Key.

27) The use of the method of repeated variation of font/distinguishing properties, as means of differentiation between same characters of Password/Encryption Key, in printed Variable Character Set system of authentication devices as claimed in claim 26.

28) The method of transformation of Variable Character Set system of authentication devices to derive new Character Units, characterized in that (a) USER optionally proposing rule or rules of transformation of characters of Password/Encryption Key/Character Units of authentication device such as shifting Serial number of Character Units of authentication device by a specified number/shifting characters from natural order by a specified number; (b) SERVICE PROVIDER optionally proposing rule or rules of transformation and USER agreeing; (c) USER keeping the rule or rules of transformation separately; (d) willing USER memorising the rule or rules of transformation on the Character Units or Basic Characters of the authentication device; (e) SERVICE PROVIDER registering the rules; (f) USER furnishing the transformed characters/Character Units for Password/Encryption Keys.

29) The use of the method of transformation of Variable Character Set system of authentication devices as claimed in claim 28.

30) The key generating process of Bilaterally Generated Encryption key System comprising; (a) USER and SERVICE PROVIDER using a pre agreed authentication device of Variable Character Set system of authentication devices; (b) the Encryption key comprising of a permutation of selected number of Character Units of the authentication device wherein optionally same Character Units are repeated in Encryption key on repetition of same random number within a Call; (c) USER approaching the SERVICE PROVIDER with opening the website or dialogue window or switching on the SERVICE PROVIDER system; (d) SERVICE PROVIDER requesting the USER to furnish USER name or identification number; (e) USER furnishing USER name or identification number; (f) SERVICE PROVIDER (f1) verifying USER name, and refusing the unregistered USER; (f2) identifying and referring to the authentication device of particular USER; (f3) generating a specified number of random numbers; (f4) ensuring each of the generated random number is less than or equal to the total number of Character Units in the authentication device and validating for specified rules; (f5) sending the random numbers to the USER, termed as Call; (g) USER responding with a continuous string of Character Units of the authentication device, wherein the serial numbers of Character Units, are the random numbers of Call, in the order of Call termed as Response; (h) SERVICE PROVIDER when required, requesting the identification number of Sub Variable Character Set of any level as part of Encryption key, along with Call and the USER complying with such request; (i) SERVICE PROVIDER (i1) verifying the Response to the Call with the respective authentication device and authenticating the USER/accepting the Encryption Key when the Response furnished is correct; (i2) allowing the USER up to specified number of chances to furnish the correct Password/Encryption key when the Response furnished in step (i1) is incorrect; (i3) denying access and advising the USER to make subsequent attempt only after specified time when USER fails to furnish the correct Password/Encryption key within specified number of chances; (i4) making the Call to furnish two Passwords/Encryption keys successively or equivalent stronger Password/Encryption key in only one chance to the USER reaching step (i3); wherein Calling two Passwords/Encryption keys or equivalent stronger Password/encryption key in only one chance provides resistance to breaking and automatically notifies the authentic USER on failed attempts (i4) denying access to the USER, who failed to provide correct Password/Encryption key in step; (j) after the initial identification/authentication, the USER desiring to ascertain the authenticity of SERVICE PROVIDER, by pre arrangement, (j1) optionally issuing a Call; (j2) SERVICE PROVIDER responding; (j3) USER verifying the Response, with the authentication device and authenticating/accepting the SERVICE PROVIDER, whereby USER and SERVICE PROVIDER mutually secure connection; (k) When required, the USER and SERVICE PROVIDER, by prior arrangement adopt padding of keys to convert the short length Password/encryption key to required length encryption key; (l) USER furnishing Password/encryption key as obtainable from authentication device, system designed to pad the keys to get keys of required length.

31) The process claimed in any preceding claim, continuous string is to combine Character Units with Basic Characters indistinguishable as belonging to particular Character Unit.

32) The process claimed in any preceding claim, stronger Password/Encryption key is a Password/Encryption key, which has twice the normal number of Character Units in a Call, designed to test physical availability of authentication device with USER after a failed attempt.

33) The process claimed in any preceding claim, padding of keys is the process of addition of characters to the user furnished encryption key to make keys with required number of characters to reduce the USER's efforts when furnishing Password/encryption key.

34) The process claimed in any preceding claim the method of padding of keys done by SERVICE PROVIDER/USER, suited to the system, wherein one method is stated herein (a) the required number of padding characters are calculated (b) the Basic Characters of Password/Encryption key are converted to the assigned serial number in the same order as it was assigned when forming the Variable Character Set or Sub Variable Character Set of any level and obtain a few random numbers; (c) the geometric mean of these random numbers is calculated; when the geometric mean is a round number the said geometric mean is multiplied by ‘π’ and the resultant number is used; (d) from the geometric mean or the resultant number in step (c) the decimal characters are extracted and used as initial seed ‘S₀’; (e) Any mathematical or statistical function such as Fishers Number, Standard normal cumulative distribution, logarithm, that takes a single input value and gives an output value is operated on ‘S₀’; (f) the decimal characters of output value of step (e) is the seed Sᵢ; (g) the random numbers obtained in step (b) are split to single digits dᵢ; (h) one or more characters to be padded is/are selected from each of one of the output value Sᵢ, starting from character at dᵢ+1; (h) steps (e) to (g) is correspondingly repeated to get as many characters that is required (i) when the first few digits of Sᵢ is/are ‘0’ then the first nonzero number is moved to first decimal position with corresponding move of all other numbers; (j) when dᵢ is even number, the numbers obtained in step (h) is placed first followed by one Character Unit of Password; when dᵢ is odd number, one Character Unit of Password is placed first followed by the numbers obtained in step (h); (k) the step (j) is repeated till all Character Units of Password is exhausted after which all remaining padding characters are appended to the string so obtained; (l) When padding encryption keys made of Calls the password corresponding to the Call is used for generating padding numbers; (m) variability between padding keys of Password and that of Call is achieved by adopting harmonic mean of random numbers obtained in step (b) and all but one Character Units of the password is also added as in step (j); (n) the algorithm for padding is a matter of prior agreement between users; (o) the padding process is done by the software and user is relieved from doing any calculation, characterized in that (p) the padding algorithm herein uses data from the Encryption key itself derived from the authentication devices of Bilaterally Generated Encryption keys; the position occurrence of numeric character is varied on par with characters of password/encryption key making the encryption key as strong as the one which is directly made from authentication device; any length of key is obtainable.

35) The process claimed in any preceding claim characterised in that (a) dispensing with memorisation; (b) enhancing the limit on maximum value of random numbers in Call, imposable by memorisation from up to human memorisable level to the total number of Character Units in the authentication device; (c) free from algorithms/pattern forming methods involving multi step procedures to produce Password/Encryption key (d) using of authentication devices of Variable Character Set system; (e) use of Double Password/encryption key Call and double strength Password/encryption key Call to prevent unauthorised persons and simultaneously bringing to the notice of the USER; (f) the process is designed to generate plurality of Passwords/Encryption keys from one password/Encryption key to secure each one of the transactions by different Encryption keys; (g) the process is designed to secure each one of the objects exchanged by different Encryption keys; (h) generating and validating Encryption keys by referring and comparing in a computationally non intensive manner.

36) The process claimed in any preceding claim, characterised in that (a) USER, includes persons and objects; (b) USER/SERVICE PROVIDER continuously verifying authenticity of SERVICE PROVIDER for every transaction; (c) the string formed by Call of random numbers is designed to serve as a variable Password/Encryption keys to authenticate/secure transactions and exchanged objects; (d) Parts (b) and (c) of this claim are used as means of generating two Encryption keys for each transaction; (e) automatic generation of Passwords/Encryption keys, facilitating transactions without human intervention; (f) generating Passwords/Encryption keys of any required level of safety.

37) The use of the key generation process of Bilaterally Generated Encryption key System as claimed in claim 30 to 36.

38) The Bilaterally Generated Encryption key, characterised in that the Encryption key is generated using the Bilaterally Generated Encryption key System including the system and interface programs executable by USER/SERVICE PROVIDER systems in which (a) all Character Units of the authentication device are repeatedly called for subsequent keys in an unrestricted manner; chance of repeating the key is equal to that of a variable Password of same Basic Characters; the repeatability is unpredictable; (b) USER is allowed to modify the font/distinguishing properties of characters/use the method of transformation of the authentication device making new Basic Characters/Character Units at any time and any number of times after the authentication device is issued.

39) The use of Bilaterally Generated Encryption keys as claimed in claim 38.

40) The Non Repeating Bilaterally Generated Encryption key, characterised in that the Encryption key is generated using the Bilaterally Generated Encryption key System, in which in every Call of Encryption key, a fixed number of Character Units of the authentication device (say 2 out of 3) are called for the first time in the span of use of authentication device between two optional transformation/font/distinguishing property changes and the balance number of Character Units (say 1 out of 3) only is repeated, the Encryption keys never repeat; including the system and interface programs executable by USER/SERVICE PROVIDER systems; (a) USER is allowed to modify the font/distinguishing properties of characters/use the method of transformation of authentication device making new Basic Characters/Character Units at any time and any number of times after authentication device is issued; (b) when the font/distinguishing properties of characters of authentication device are modified/transformation of the authentication device in use is effected, the authentication device is fully available afresh, for calling of any Character Units, for generating Encryption keys.

41) The use of Non Repeating Bilaterally Generated Encryption keys as claimed in claim 40.

42) The method of authenticating and securing of every individual Internet Contract/Network transaction of USER with one Password/Encryption key furnished by a USER for each transaction {FIG. 5}, using Bilaterally Generated Encryption key System characterised in that authenticating and securing of transactions, using Call and Password as two different computationally non intensive encryption keys padded optionally, linked to USER's identity to each one of the Internet/network transactions with one Password/Encryption key per transaction furnished by USER; two way authentication and access restriction of object/message exchanged; ensuring continuity of link between SERVICE PROVIDER and USER from beginning till end of session; including the authentication/securing logic, authentication/securing system and the authentication/securing system programs executable by USER and SERVICE PROVIDER systems, comprising steps of (a) SERVICE PROVIDER and USER (a1) recording their mutual Internet Protocol/Network addresses at the beginning of a session; (a2) using the string formed by Call of random numbers as additional Passwords/encryption keys, the method herein, ensuring all Calls excluding the initial Call of the session, remain unexposed; padding optionally the USER/SERVICE PROVIDER furnished keys and Calls to get required length of encryption keys and using (a3) placing all unexposed Calls, Passwords/Encryption keys and file or message packets in to folders, exchanging the folders after encrypting and access restricting using any one of unexposed Calls/Passwords as Passwords and encryption keys, the cryptographic algorithm to encrypt and padding algorithm are pre agreed; all the unexposed Calls/Password/encryption keys generated up to a transaction in a session is available for encrypting and access restricting a specific folder by prior agreement; preferring use of the Call for a particular transaction for object exchange from USER to SERVICE PROVIDER and Password/encryption key for the same transaction for object exchange from SERVICE PROVIDER to USER; (a4) access restriction and maintaining continuity of link by ensuring IP address from which USER or SERVICE PROVIDER are transacting remains the one and the same from beginning to end of session and by obtaining a variable Password/Encryption keys known only to USER and SERVICE PROVIDER, from the respective systems, for each object exchanged; the method of access restriction to specific IP address, supporting the likelihood of masking of IP addresses, continuously changing of IP addresses, using proxy servers, or similar techniques; (a5) confirming correctness of Calls, Passwords/Encryption keys and allowing pre agreed number of chances to rectify; exiting upon failure to rectify or lapse of time or inability to open or decrypt folders; (a6) optionally checking objects exchanged before accepting, the checks are for compliance of regulations, contract conditions, and freedom from undesirable programs like virus; (a7) preventing breach attempts on the encryption key both when the USER and SERVICE PROVIDER are in session or not in session (b) USER furnishing USER Name and issuing a Call termed as ‘initial Call of the session’ to SERVICE PROVIDER; (c) SERVICE PROVIDER creating a folder containing Password/encryption key for initial Call of the session, a Call, termed as ‘SERVICE PROVIDER's first Call’ and optional message, encrypting and access restricting the folder as detailed in step (a); sending the folder to USER (d) USER opening and decrypting the folder, checking Password/encryption key; creating a folder containing Password/encryption key for SERVICE PROVIDER's first Call, any message, encrypting and access restricting the folder as detailed in step (a); sending the folder to SERVICE PROVIDER; (e) SERVICE PROVIDER opening and decrypting the folder, verifying Password/encryption key from USER; creating a folder containing next Call, authentication message, encrypting and access restricting the folder as detailed in step (a); sending the folder to USER; (f) USER opening and decrypting the folder, getting the next Call; (g) After an Internet Contract/Network Transaction is created, USER, creating a folder containing Password/Encryption keys for the Call obtained in previous step, and the file or message packet containing the USER's Internet Contract/Network Transaction; encrypting and access restricting the folder as detailed in step (a); sending the folder to SERVICE PROVIDER (h) SERVICE PROVIDER opening and decrypting the folder, verifying Password/Encryption key furnished by USER, checking and processing the contents of file or message packet; responding by creating a folder containing Call for the next transaction and the file or message packet containing the SERVICE PROVIDER's Internet Contract/Network Transaction; encrypting and access restricting the folder as detailed in step (a); sending the folder to USER; (i) USER opening and decrypting the folder from SERVICE PROVIDER, checking and processing the contents of file or message packet; (j) Repeating steps (g) to (i), till the transactions are completed and exiting after advising SERVICE PROVIDER.

43) The use of the method of authentication and securing of every individual Internet Contract/Network transactions with one Password/encryption key furnished by a USER for each transaction, using Bilaterally Generated Encryption Key System, including the authentication/securing logic, the authentication/securing system and the authentication/securing system programs executable by USER and SERVICE PROVIDER systems claimed in claim 42.

44) The method of authenticating and securing of every individual Internet Contract/Network transaction with different Passwords/Encryption Keys, generating said different Passwords/Encryption keys from single Password/encryption key furnished at the beginning of a session of by a known USER {FIG. 6}, having USER account with that SERVICE PROVIDER, using Bilaterally Generated Encryption keys System, characterised in that using a USER Agent Software, to generate many variable Passwords/Encryption keys padded optionally from one initial Password/encryption key furnished by a USER, at the beginning of the session, authenticating and securing of transactions, using Call and Password as two different computationally non intensive encryption keys linked to USER's identity to each one of the Internet/network transactions between USER and SERVICE PROVIDER; two way authentication and access restriction of objects/messages exchanged using two different Passwords/encryption keys padded optionally for each transaction; ensuring continuity of link between SERVICE PROVIDER and USER from beginning till end of session; providing proof for every Internet Contract/Network Transaction of USERs; providing direct and computationally non intensive means of tracing all actions/objects of USERs from access to exit, to solve Internet Contract/Network Transaction related claims; including authentication/securing logic, authentication/securing system and system interface programs executable by USER and SERVICE PROVIDER systems, comprising steps of (a) USER's System using USER Agent Software, representing USER, transacting with SERVICE PROVIDER; the USER Agent software, is integrated with Internet Contract/Network Transactions software or an independent software, which is assigned the Internet Protocol/Network address of the computer, wherefrom, USER accesses the SERVICE PROVIDER, as the temporary session USER name; (b) the pre agreed authentication device, have same number of Basic Characters per Character Unit for all Character Units; (c) SERVICE PROVIDER and USER/USER Agent Software (c1) recording their mutual Internet Protocol/Network addresses at the beginning of a session; (c2) using the string formed by Call of random numbers as additional Passwords/encryption keys, the method herein, ensuring all Calls excluding the initial Call of the session, remains unexposed; padding optionally the USER/SERVICE PROVIDER furnished keys and Calls to get required length of encryption keys and using; (c3) placing all unexposed Calls, Password/encryption keys and file or message packets in to folders, exchanging the folders after encrypting and access restricting using any one of unexposed Calls/Passwords as Passwords and encryption keys, the cryptographic algorithm to encrypt and padding algorithm are pre agreed; the choice of specific Call or specific Password/encryption key from among the Calls or Password/encryption keys generated up to that transaction in a session for encrypting and access restricting a specific folder is by availability or prior agreement; preferring use of the Call for a transaction for object exchange from USER/USER Agent Software to SERVICE PROVIDER and the Password/encryption key for a transaction for object exchange from SERVICE PROVIDER to USER/USER Agent Software; (c4) access restriction and ensuring continuity of link is by ensuring IP address from which USER/USER Agent Software or SERVICE PROVIDER are transacting remains the one and the same from beginning to end of session and by obtaining a variable Password/encryption key known only to USER/USER Agent Software and SERVICE PROVIDER for each object exchanged from the respective systems; the method of access restriction to specific IP address, supporting the likelihood of masking of IP addresses, continuously changing of IP addresses, using proxy servers, or similar techniques; (c5) confirming correctness of Calls, Passwords/Encryption keys and allowing pre agreed number of chances to rectify; exiting upon failure to rectify or lapse of time or inability to open or decrypt folders (c6) optionally checking objects exchanged before accepting, the checks are for compliance of regulations, contract conditions, and freedom from undesirable programs like virus; (c7) preventing breach attempts on the encryption key both when the USER and SERVICE PROVIDER are in session or not in session; (d) USER furnishing USER Name and issuing a Call of minimum 4 random numbers, termed as ‘initial Call of the session’ to SERVICE PROVIDER; (e) SERVICE PROVIDER creating a folder containing Password/Encryption Key for initial Call of the session, a Call of minimum number of random numbers as in initial Call of the session termed as ‘SERVICE PROVIDER's first Call’ and optional message, encrypting and access restricting the folder as detailed in step (c); sending the folder to USER (f) USER opening and decrypting the folder, checking Password/encryption key; creating a folder containing Password/encryption key for SERVICE PROVIDER's first Call, any message, encrypting and access restricting the folder as detailed in step (c); sending the folder to SERVICE PROVIDER; (g) SERVICE PROVIDER opening and decrypting the folder, verifying Password/encryption key from USER; creating a folder containing authentication message, encrypting and access restricting the folder as detailed in step (c); sending the folder to USER; (h) USER opening and decrypting the folder, authorising USER Agent Software for doing transactions passing on Password/encryption key furnished in step (f) and Call received in step (e); (f) USER Agent Software forming a Sub Variable Character Set of any Level, using all Character Units of the Password/encryption key furnished in step (f), assigning Serial Number of Character Units as Call received in step (e) or in a different manner and using it as the authentication device of that session (g) specifying minimum number of Character Units is to ensure at least 60 unique Password/encryption keys are formed from authentication device of the session with 2 or 3 or 4 Character Unit, Calls with different permutations at random.

45) The method as claimed in claim 44, (a) USER Agent Software creating a folder containing assigned Serial Number of Character Units and request for a Call; encrypting and access restricting the folder as in step (c) of claim 44; sending it to SERVICE PROVIDER (b) SERVICE PROVIDER upon confirming the Internet Protocol/Network address of the USER Agent Software and USER are same, opening and decrypting the folder, registering Serial Number of Character Units, creating a folder containing Call within the authentication device of the session, encrypting and access restricting the folder as in step (c) of claim 44, sending it to USER Agent Software; USER Agent Software opening and obtaining the Call for next transaction; (c) USER creating Internet Contract/Network Transaction and passing on to USER Agent Software; USER Agent Software checking for the origination Internet Contract/Network Transaction from within USER system such as; (c1) ensuring continuity of connection with SERVICE PROVIDER; (c2) ensuring the integrity of command to do the Internet Contract/Network Transaction, through checking the keyboard and other input entries (c3) upon confirming the origination, the USER Agent Software, (c4) creating a folder containing Password/Encryption keys for the Call obtained in step (b) and the file or message packet containing the USER's Internet Contract/Network Transaction; (c5) encrypting and access restricting the folder as in step (c) of claim 44; (c6) sending the folder to SERVICE PROVIDER (d) SERVICE PROVIDER opening and decrypting the folder, (d1) verifying Password/Encryption keys furnished by USER Agent Software; (d2) checking and processing the contents of file or message packet; (d3) responding by creating a folder containing Call for the next transaction and the file or message packet containing the SERVICE PROVIDER's Internet Contract/Network Transaction (d4) encrypting and access restricting the folder as in step (c) of claim 44; (d5) sending the folder to USER Agent Software; (e) USER Agent Software opening and decrypting the folder from SERVICE PROVIDER, checking and passing on the file or message packet to USER; retaining the Call; (f) repeating steps (c) to (e) till the transactions are completed and exiting after advising SERVICE PROVIDER.

46) The method as claimed in claims 44 to 45 (a) the interaction between USER Agent Software and SERVICE PROVIDER proceeds sans the USER efforts, wherein the USER Agent Software upon encryption key failure, informing the USER to decide corrective action; (b) providing for USER to optionally do authentications/securing directly or at any time, interrupt the USER Agent Software, duly noting the SERVICE PROVIDER's first Call or Password/encryption key furnished for SERVICE PROVIDER's first Call; (c) wherein unauthorised USER created Internet Contract/Network Transactions are denied access to the authentication device of the session; (d) access restriction to Internet Protocol/Network address blocks the unauthorised, from substituting the USER/USER Agent Software/SERVICE PROVIDER, through any other computer; (e) USER Agent Software rejects the attempts to originate Internet Contract/Network Transaction from the USER's Computer, through remote commands; (f) SERVICE PROVIDER optionally keeping proof for every transaction of USERs including the USER name, the IP address of USER system, the date and time, the details of Internet Contract/Network Transaction, the Call and the Password/encryption key for each transaction; (g) providing direct and computationally non intensive means of tracing all actions/objects of a USER/SERVICE PROVIDER from access to exit, to solve Internet Contract Transaction/Network Transaction related claims.

47) The use of the method of authenticating and securing of every individual Internet Contract/Network transaction with different Passwords/Encryption keys, generating said different Passwords/Encryption keys from single Password/Encryption Key furnished at the beginning of a session of by a known USER, having USER account with that SERVICE PROVIDER, using Bilaterally Generated Encryption Key System including the authentication/securing logic, the authentication/securing system and the authentication/securing system programs executable by USER and SERVICE PROVIDER systems as claimed in claim 44 to 46.

48) The method of authenticating and securing of every individual Internet/Network transaction of a previously unknown USER with different Password/Encryption Keys, generating said different Password/Encryption Keys from one Password/encryption key furnished from a temporary authentication device at the beginning of a session by such previously unknown USER {FIG. 7} using Bilaterally Generated Encryption Key System, characterised in that using a USER Agent Software, to generate many variable Password/Encryption Keys from one initially furnished Password/encryption key from a temporary authentication device sent by a SERVICE PROVIDER to a previously unknown USER, at the beginning of the session, authenticating and securing of transactions, using Call and Password, padded optionally as two different computationally non intensive encryption keys linked to USER's identity to each one of the Internet/network transactions between previously unknown USER and SERVICE PROVIDER; two way authentication and access restriction of objects/messages exchanged; ensuring continuity of link between SERVICE PROVIDER and previously unknown USER from beginning till end of session; providing proof for every Internet Contract/Network Transaction of previously unknown USERs; providing direct and computationally non intensive means of tracing all actions of a previously unknown USER from access to exit, to solve Internet Contract/Network Transaction related claims; including authentication/securing logic, authentication/securing system and system interface programs executable by USER and SERVICE PROVIDER systems, comprising steps of (a) previously unknown USER's System using USER Agent Software, provided on request by SERVICE PROVIDER, representing previously unknown USER, transacting with SERVICE PROVIDER; USER Agent software, is integrated with Internet Contract/Network Transactions software or an independent software, which is assigned the Internet Protocol/Network address of the computer, wherefrom, previously unknown USER accesses the SERVICE PROVIDER, as the temporary session USER name; (b) SERVICE PROVIDER and previously unknown USER/USER Agent Software (b1) recording their mutual Internet Protocol/Network addresses at the beginning of a session; (b2) using the string formed by Call of random numbers as additional Passwords/encryption keys, the method herein, ensuring all Calls remains unexposed; padding optionally the USER/SERVICE PROVIDER furnished keys and Calls to get required length of encryption keys and using (b3) placing all unexposed Calls, Password/Encryption Keys and file or message packets in to folders, exchanging the folders after encrypting and access restricting using the Call for a transaction for object exchange from previously unknown USER/USER Agent Software to SERVICE PROVIDER and the Password/Encryption Key for a transaction for object exchange from SERVICE PROVIDER to previously unknown USER/USER Agent Software, the cryptographic algorithm to encrypt and padding algorithm are provided by SERVICE PROVIDER and used by the USER; (b4) access restriction and ensuring continuity of the link is by ensuring IP address from which the previously unknown USER/USER Agent Software or SERVICE PROVIDER are transacting remains the one and the same from beginning to end of session and by obtaining a variable Password/Encryption Key known only to previously unknown USER/USER Agent Software and SERVICE PROVIDER for each object exchanged from respective systems; the method of access restriction to specific IP address, supporting the likelihood of masking of IP addresses, continuously changing of IP addresses, using proxy servers, or similar techniques; (b5) confirming correctness of Calls, Password/Encryption Keys and allowing pre agreed number of chances to rectify; exiting upon failure to rectify or lapse of time or inability to open or decrypt folders (b6) optionally checking objects exchanged before accepting, the checks are for compliance of regulations, contract conditions as agreed at the commencement of session, and freedom from undesirable programs like virus; (b7) preventing breach attempts on the encryption key both when the USER and SERVICE PROVIDER are in session or not in session when required;

49) The method as claimed in claims 48 (a) previously unknown USER requesting a known Internet SERVICE PROVIDER/Network server to facilitate transactions with an unknown SERVICE PROVIDER, furnishing the domain name of the website or IP address of the SERVICE PROVIDER; (b) Internet SERVICE PROVIDER/Network server authenticating said USER with a Password from that USER's account, conveying the request of the said USER, passing on the USER name, the IP address of the USER and USER data as required to that SERVICE PROVIDER; (e) SERVICE PROVIDER, (c1) considering the request; (c2) when unwilling to transact with that USER, conveying unwillingness through the Internet SERVICE PROVIDER/Network server to that USER; (c3) when willing to transact with that previously unknown USER, storing a newly assigned USER name, linked with validated USER data furnished by Internet SERVICE PROVIDER/Network server, IP address of the USER and IP address of Internet SERVICE PROVIDER/Network server for record; (c4) creating a folder containing temporary Sub Variable Character Set of minimum 8 Character Units and a Call for the Internet SERVICE PROVIDER or Network server, a sub folder for Previously Unknown USER containing temporary USER Name, temporary Sub Variable Character Set of minimum 8 Character Units of equal number of Basic Characters in all Character Units and a Call for minimum 4 Character Units; (c5) encrypting and access restricting the subfolder to IP address of Previously Unknown USER as USER Name with a Password; (c6) sending the folder to Internet SERVICE PROVIDER or Network server; (d) Internet SERVICE PROVIDER/Network server conveying SERVICE PROVIDER's unwillingness to USER or opening the folder, furnishing Password to SERVICE PROVIDER, passing on the subfolder to USER and exiting; (e) SERVICE PROVIDER checking Password from Internet SERVICE PROVIDER/Network server and upon finding it correct, sending the Password to open the subfolder directly to Previously Unknown USER (f) previously unknown USER exiting on unwillingness of SERVICE PROVIDER to transact or opening the subfolder using Password received from SERVICE PROVIDER and obtaining temporary Sub Variable Character Set (g) Previously Unknown USER accessing SERVICE PROVIDER's website, recording IP address of SERVICE PROVIDER, furnishing USER Name, creating folder containing Password to the Call received in the subfolder, encrypting and access restricting as in step (b) of claim; sending the folder to SERVICE PROVIDER; (j) SERVICE PROVIDER verifying USER Name, recording IP address of USER, locating authentication device; upon finding the Password/encryption key as correct, advising about successful authentication, for that session, from when on, that previously unknown USER becomes an authenticated but temporary USER to that SERVICE PROVIDER; (k) previously unknown USER, authorising USER Agent Software to act further passing on the Password/encryption key and Call used for initial access; (l) USER Agent Software forming a Sub Variable Character Set of any Level, using all Character Units of the Password/encryption key for initial access, assigning Serial Number of Character Units as Call for initial access or in a different manner and using it as the authentication device of that session; (m) specifying minimum number of Character Units is to ensure that at least 60 unique Password/encryption keys are formed using the authentication device of that session with 2 or 3 or 4 Character Unit, Calls with different permutations at random.

50) The method as claimed in claim 48 to 49, (a) USER Agent Software seeking a Call; (b) SERVICE PROVIDER upon confirming the Internet Protocol/Network address of the USER Agent Software and temporary USER are same, creating a folder containing Call within the authentication device of the session, encrypting and access restricting the folder as in step (b) of claim 48, sending it to USER Agent Software; USER Agent Software opening and obtaining the Call for next transaction; (c) temporary USER creating Internet Contract/Network Transaction and passing on to the USER Agent Software; USER Agent Software checking for the origination Internet Contract/Network Transaction from within temporary USER's system such as; (c1) ensuring continuity of connection with SERVICE PROVIDER; (c2) ensuring the integrity of command to do the Internet Contract/Network Transaction, through checking the keyboard and other input entries (c3) upon confirming the origination, the USER Agent Software, (c4) creating a folder containing Password/Encryption Key for the Call obtained in step (b) and the file or message packet containing the temporary USER's Internet Contract/Network Transaction; (c5) encrypting and access restricting the folder as in step (b) of claim 48; (c6) sending the folder to SERVICE PROVIDER (d) SERVICE PROVIDER opening and decrypting the folder, (d1) verifying Password/Encryption Key furnished by USER Agent Software; (d2) checking and processing the contents of file or message packet; (d3) responding by creating a folder containing Call for the next transaction and the file or message packet containing the SERVICE PROVIDER's Internet Contract/Network Transaction; (d4) encrypting and access restricting the folder as in step (b) of claim 48; (d5) sending the folder to USER Agent Software; (e) USER Agent Software opening and decrypting the folder from SERVICE PROVIDER, checking and passing on the file or message packet to temporary USER; retaining the Call (f) Repeating steps (c) to (e) till the transactions are completed and exiting after advising SERVICE PROVIDER.

51) The method as claimed in claims 48 to 49, (a) the interaction between the USER Agent Software and SERVICE PROVIDER proceeds sans the temporary USER's efforts, wherein the USER Agent Software upon encryption key failure, informing the temporary USER to decide corrective action; (b) providing for temporary USER to optionally do authentications/securing directly or at any time, interrupt the USER Agent software, duly noting the initial Call and Password/encryption key; (c) wherein unauthorised USER created Internet Contract Transaction/Network Transactions are denied access to the authentication device of the session; (d) access restriction to Internet Protocol/Network address blocks the unauthorised, from substituting the temporary USER/USER Agent Software/SERVICE PROVIDER, through any other computer; (e) USER Agent Software rejects the attempts to originate the Internet Contract/Network Transaction from the temporary USER's Computer, through remote commands; (f) SERVICE PROVIDER optionally keeping proof for every transaction of temporary USERs including IP address of the Internet SERVICE PROVIDER/Network server who forwarded the request from USER, the USER name, the IP address of USER system, the date and time, the details of Internet Contract/Network Transaction, the Call and the Password/Encryption Key for each transaction; (g) providing direct and computationally non intensive means of tracing all actions/objects of a temporary USER/SERVICE PROVIDER from access to exit, to solve Internet Contract/Network Transaction related claims of previously unknown USERs.

52) The use of the method of authenticating and securing of every individual Internet/Network transaction of a previously unknown USER with different Password/Encryption Keys, generating said different Passwords/encryption keys from one Password/encryption key furnished from a temporary authentication device at the beginning of a session by such previously unknown USER using Bilaterally Generated Encryption Key System including the authentication/securing logic, the authentication/securing system and the authentication/securing system programs executable by USER and SERVICE PROVIDER systems as claimed in claims 48 to 51.
